(19) United States
(12) Patent Application Publication
(10) Pub. No.: US 2014/0122346 A1
(43) Pub. Date: May 1, 2014

(54) METHOD, APPARATUS, SYSTEM, AND COMPUTER READABLE MEDIUM FOR LEASING SPACE

(71) Applicant: JONES LANG LASALLE IP, INC., (US)

(72) Inventors: Andrew Dillon O'BRIEN, Washington, DC (US); Alex Nathan LASSAR, Washington, DC (US)

(73) Assignee: JONES LANG LASALLE IP, INC., Washington, DC (US)

(21) Appl. No.: 13/840,853

(22) Filed: Mar. 15, 2013

Related U.S. Application Data
(60) Provisional application No. 61/616,728, filed on Mar. 28, 2012.

(51) Int. Cl. G06Q 30/06

(52) U.S. Cl. CPC G06Q 30/0645
USPC 705/307

(57) ABSTRACT

An integrated leasing method, system, apparatus, and a computer readable medium for leasing a space including a small fraction thereof separately by aggregating multiple tenants and for providing one place to bid for and commensurate an entire transaction related to the leasing. A method, a system, an apparatus, and a computer-readable medium for leasing a space including receiving space location and space related information, which comprises information regarding at least one component within the space, processing by a computer the at least one component based on a user request, and outputting the result of said processing. The component includes at least one of a seat, a section, and an amenity related to the space.

### CROSS REFERENCE TO RELATED APPLICATIONS

This application claims the benefit pursuant to 35 U.S.C. §120 of the filing data of the U.S. Provisional Application No. 61/616,728 filed on Mar. 28, 2012, and titled “LEASEUP”, the entire disclosure of which is incorporated herein by reference in its entirety.

### BACKGROUND

1. Field

Methods, apparatuses, systems, and computer readable mediums consistent with exemplary embodiments broadly relate to leasing space, and more specifically, to aggregating leases for a space.

2. Description of the Related Art

In today's market, leasing commercial space such as large office spaces, data centers, warehouses, etc., is often difficult and takes a long time to find the appropriate tenants. Often times, large spaces are rented for a long term (3+ years) and require a thorough review of potential tenants, as well as a lengthy, non-standardized negotiation process. As a result, many spaces stand empty for prolonged periods of time between the long term leases, resulting in wasted space. The average vacancy rate for office space nationwide, for instance, hovers at or around the 20% mark for many major U.S. markets at any given point in time. Even the most efficient office markets in the country rarely break the single-digit vacancy mark.

At the same time, individual persons or small companies have difficulties finding commercial space. Due to the volatile nature of small businesses and changing needs of individuals, coupled with the credit, capital and lease term requirements imposed by landlords within the current marketplace framework, finding leased space, especially for small tenants, is difficult. Often times, small companies or individuals end up with long term leases of two or more years, frequently with too much or otherwise under-utilized space within the premises (for growth). Coupled with no options to expand or contract, much more flexible and shorter term leases would have been preferred. Leasing space today is certainly an ‘if the shoe fits’ business, and often-times it does not.

Accordingly, there is a need in the art to improve the leasing industry and better match tenants and landlords, or even tenants and co-tenants.

Further, there is a need in the art to improve the leasing and/or utilization of amenities related to the space, especially as dedicated spaces shrink and common spaces grow within workspaces, as is the current trend.

Further, there is a need in the art, to move the process of leasing to an online environment and to provide an integrated online solution for the leasing market.

### SUMMARY

An aspect, among other aspects, which will become apparent from reading the description herein of exemplary embodiments, is to provide a system to overcome the above-mentioned problems by facilitating transactions between tenants and landlords.

Another aspect, among other aspects, is to provide an automated system in which small tenants are aggregated to bid for and obtain a lease for one larger space. Alternative exemplary embodiments will be presented as part of the discussion.

Illustrative, non-limiting embodiments may overcome the above-noted disadvantages and problems in the prior art, and also may have been developed to provide solutions to other disadvantages and problems that were not described above. However, a method, an apparatus, a system, and a computer readable medium that operates according to the teachings of the present disclosure is not necessarily required to overcome any of the particular problems or disadvantages described above. It is understood that one or more exemplary embodiment is not required to overcome the disadvantages described above, and may not overcome any of the problems described above.

According to an exemplary embodiment, a method, a system, an apparatus including a memory and a processor and a non-transitory computer readable medium for leasing a space is provided. The method includes receiving space location and space related information, which comprises information regarding at least one component within the space; processing by a computer the at least one component based on a user request; and outputting the result of said processing, where the component includes at least one of a seat, a section, and an amenity related to the space

### BRIEF DESCRIPTION OF THE DRAWINGS

The accompanying drawings, which are incorporated in and constitute a part of this specification exemplify the exemplary embodiments and, together with the description, serve to explain and illustrate exemplary embodiments. Specifically:

FIG. 1 is a block diagram illustrating a system for providing leasing related transactions according to an exemplary embodiment.

FIG. 2 is a block diagram illustrating a server apparatus for facilitating lease related transactions according to an exemplary embodiment.

FIG. 3 is a flow chart illustrating a method of generating a lease related listing according to an exemplary embodiment.

FIGS. 4A-4D are views illustrating user interfaces for generating seats and/or sections for a space according to various exemplary embodiments.

FIGS. 5A and 5B are views illustrating user interfaces for managing listings of a user according to an exemplary embodiment.

FIG. 6 is a flow chart illustrating a method of leasing a space according to an exemplary embodiment.

FIG. 7 is a flow chart illustrating a method of searching for potential tenants according to an exemplary embodiment.

FIG. 8 is a flow chart illustrating a method of searching for tenant preferences according to an exemplary embodiment.

FIGS. 9A-9C are views illustrating displaying results of a tenant preference search according to an exemplary embodiment.

FIG. 10 is a flow chart illustrating a method of searching for a space according to an exemplary embodiment

FIG. 11 is a view illustrating a user interface for searching for a space and providing results of a search according to an exemplary embodiment.

FIGS. 12A and 12B are views illustrating a user interface for providing detailed information about a space according to an exemplary embodiment.

FIG. 13 is a flow chart illustrating a method of selecting seats in a space according to an exemplary embodiment.

FIGS. 14A and 14B are views illustrating user interfaces for selecting seats in a space according to exemplary embodiments.

FIG. 15 is a flow chart illustrating a method of making a reservation of a selected seat or seats in a space or spaces according to an exemplary embodiment.

FIGS. 16A and 16B are views illustrating user interfaces for making a reservation of a selected seat or seats, section or sections, and/or pass or passes, in a space or spaces according to an exemplary embodiment.

FIG. 17 is a flow chart illustrating a method of completing a lease related transaction according to an exemplary embodiment.

FIG. 18 is a view illustrating reserved space according to an exemplary embodiment.

### DETAILED DESCRIPTION OF EXEMPLARY EMBODIMENTS

Exemplary embodiments will now be described in detail with reference to the accompanying drawings. Exemplary embodiments may be embodied in many different forms and should not be construed as being limited to the illustrative exemplary embodiments set forth herein. Rather, the exemplary embodiments are provided so that this disclosure will be thorough and complete, and will fully convey the illustrative concept to those skilled in the art. Also, well-known functions or constructions may be omitted to provide a clear and concise description of exemplary embodiments. The claims and their equivalents should be consulted to ascertain the true scope of an inventive concept.

In an exemplary embodiment, a leasing system is provided that allows users of space (“Tenants”) to search for and transact leases for space with space ‘owners’ (“Landlords/Sublandlords”). In an exemplary embodiment, individual users (individual persons or companies) gain access to and transact leases in spaces that they may not have the ability to transact a lease/license for individually, but can transact a lease/license for in the aggregate. An exemplary embodiment provides a peer-to-peer online marketplace whereby Landlords/Sublandlords can post vacant office space normally reserved for larger and/or longer-term tenants and/or which are challenging to lease, e.g., only temporarily available, etc. and individuals or companies/groups of individuals may search, communicate, aggregate together, and transact a lease(s)/license(s) for such space. That is, Landlords of a medium to large spaces usually look for a company of substantial size and prefer a long-term lease. While Landlords find such tenants, the office space remains vacant, which is a waste.

In an exemplary embodiment, tenants are aggregated together to either obtain a better rent through not leasing excess space, share or otherwise build tenant credit and capital, or otherwise work in an environment and with other tenants that is more or less fully self-selected without the need for a ‘master’ tenancy. In an exemplary embodiment, efficiencies that do not exist without the aggregation are obtained. In an exemplary embodiment, small tenants may be aggregated together to obtain one large office space.

Moreover, in an exemplary embodiment, the leasing process is facilitated. The transaction process (and inability to coordinate it) as it exists today is one of the largest barriers to consuming space in the way proposed by the exemplary embodiment. Online leasing transaction is made simply and on the fly. In an exemplary embodiment, the potential tenants may bid, organize, lease/purchase, sign documents, and obtain insurance, all in one place. In other words, a leasing transaction may be easily facilitated on the fly via the leasing application. The spaces may be office spaces, data center spaces e.g., racks, multi-family apartment or town house where the space is shared among a number of tenants, industrial equipment where a factory or a manufacturing plant is shared by multiple manufacturers, and so on.

Further, in another exemplary embodiment, alternatively or in addition to leasing space, the leasing may be of services. The services may relate to space, and may further facilitate the sharing of such space. For example, the services being leased may include administrative services, receptionist services, parking services, virtual hosting, and so on. The services may be provided on an amenities card, which package various services together. These services may be a separate listing on the system and may be sold separately from space. The owner and organizer of these services may be the landlord or it may be one or more of the tenant(s) in the space. In this way the space can act as a more traditional pre-sponsored ‘managed space’ or business center, or one or more of the tenants within the space could easily set up these resources within the exemplary embodiment to mimic a more established company in a larger space.

A small tenant may want to lease a medium to large sized spaces because they are often-times much better equipped with tenant amenities and features, not to mention better identity on a floor or within a building, or simply provides access to more co-workers either within or between several companies. In an exemplary embodiment, a larger space is broken into ‘shares’ or ‘seats’, which are then effectually leased up on a share-by-share/seat-by-seat basis, as described in greater detail below. Individual persons may lease/license single seats/shares, and/or companies may lease/license designated blocks of them i.e., sections including more than one seat/share.

In an exemplary embodiment, two ‘checks and balances’ are provided, which are 1) the space, such as an office, is offered for a limited time by the Landlord/Sublandlord and 2) the transaction is not effectuated unless a minimum occupancy/rental income threshold (over a certain lease term) is reached before the offer is honored by the Landlord/Sublandlord (what is known in the industry as a ‘minimum rental recovery’ or ‘pro-form a’). Only then are the leases/licenses between pre-approved tenants and Landlords/Sublandlords consummated.

### Concepts and Definition Used in Exemplary Embodiments

In exemplary embodiments, the following definitions and concepts are described. These exemplary concepts and definitions are to be applied to exemplary embodiments only and are provided by way of an example. These exemplary embodiments are not intended to limit the scope of an inventive concept and are illustrative and non-limiting.

Tenant is a user of an office space, who may be an individual or a company comprised of individuals.

Owner is a landlord or a sub-landlord of space.

Salesforce is one or more representative who support Owners in creating online listings, as well as provide various customer support activities to both Owners and Tenants.

Lease is a contract to pay a certain price for a certain unit of space within a certain Premises within a building for a certain period of time, generally also containing other business terms. Such unit may be an individual Seat, or multiple Seats such as a Section in aggregate. The Lease will be a in the form and substance chosen by each Landlord for every transaction. The Lease for a transaction is will be created and uploaded by a Landlord, and may be accepted and signed by the Landlord and by a Tenant. Once ‘accepted’ by both parties, the Lease is legally binding.

Transaction is the process whereby one or more Seats are leased online by Tenants. For example, a Transaction may be initiated by the Tenant (who has accepted the website Terms of Service and logged-in) choosing the Seat(s) on a Seating Chart, and electronically signing the Lease Once the Landlord accepts the Tenant's ‘application’ (i.e., the ‘signed’ agreement plus details about the seats, pricing, and lease term), the Tenant's leasehold income goes towards the Landlord's pre-determined Tipping Point, and the Tenant's funds for a pre-determined amount of pre-paid monthly Rent (and/or Deposit) are placed into an escrow account (or otherwise pre-authorized to be debited by the payment mechanism). Once the Tipping Point is reached by one or multiple lease ‘orders’ (or a Final Offer is re-offered, or a deal is ‘called’ by the Landlord), the debiting from escrow or pre-authorized accounts of the pre-paid monthly Rent (and/or Deposit) occurs. Tenant(s) subsequently move-into the Premises at a later, pre-determined date.

Listing is a record containing information about Premises within a property and the units (Seats/Shares) available within the Premises for lease by an Owner to Tenants.

Term is the initial period of time whereby Owner will honor the pricing, terms, and conditions of the Lease for the Seat(s) within a LeaseUp Premises. Thereafter, the Seat(s) may convert to a second agreed-upon Term of multiple months or years (extension), or month-to-month leases, or cancellable by either party.

Premises is a demised (or to-be-demised) suite within a larger building (or a stand-alone building if smaller). Seats/Shares are available within Premises, as well as other shared common amenities and features being available to be leased. Premises and/or sections of them may be available in their entirety under different lease terms than Seats/Shares, and displayed as such.

Seat/Share is a specific unit of space within Premises available for an individual or company to lease provided to a single individual or a small company for use during the term of the Lease (and as may be extended by such in accordance with the terms of the lease, and if so chosen, through the system) on a reserved basis. A seat may be a cubicle, an office, or may represent a ‘share’ of an unfurnished or even completely or partially unfinished (“shell”) of an office space by way of an example.

Section is a specific unit of space within Premises available for an individual or company to lease and which includes more than one seat. Discounts based on volume/Section may be garnered via leasing multiple Seats/Shares within a Section(s), or the terms and conditions for a Section could be offered on more ‘traditional’ terms to tenant(s).

Floor Plan is a two or even three dimensional digital image file that shows the layout of the Premises and Seats within the space. Floor plans may be included as parts of larger ‘blocking’ plans to show where on the floor the suite/Premises is and key elements such as exterior windows/views (e.g. Faces street, alley, etc.), elevators, etc. Floor plans may represent existing (built and furnished spaces), or hypothetical to-be-built and furnished spaces.

Seating Chart is an interactive animation that displays meta-information about Seats/Shares, Sections and Premises on a Floor Plan. It may include an automatically populated color coding scheme, shape coding scheme, size coding scheme and label/icon providing scheme. For example, a Seating Chart may depict whether a Seat/Share, or Premises is reserved or available and Pricing and other information when the Seat/Share or Premises is selected. In an exemplary embodiment, a capability to roll over for meta-information about Seats/Shares and Sections, and ‘click on’ to reserve a Seat may be provided.

Video Walkthrough is a video or other technology that shows what the space looks like e.g. from a first person perspective while also displaying the corresponding camera location and direction on a Floor Plan, 3D, marked camera location, manipulated by user, etc. . . . .

Pictures are still photographs that show what the space looks like from a first person perspective while also possibly displaying the corresponding camera location and direction on a Floor Plan, or otherwise showing an image associated with a Seat/Share within the meta-information provided.

Pricing is a collection of financial information concerning a Listing and the Seats/Shares or Premises within it.

Pro Form a rent/Tipping Point is the threshold amount of total aggregate rent (Seats X Pricing per Seat X lease Term) that an Owner requires are ‘Checked-out’ in order to complete/consummate a transaction with all Tenants who have reserved a Seat(s)/electronically signed leases, and have been subsequently approved by the Landlord, within that Premises.

Final Offer is a re-offer to each Tenant at a new, slightly higher Pricing for their Seat(s) (Seats X (Original Pricing per Seat+Final Offer up-charge)) if the Tipping Point is not initially met.

Call Deal/Push the Deal—Listers will create listings with their best estimate of, or otherwise desired price, to create the Tipping Point. Since the Tipping Point is used to, from the day the listing hits the market initially, influence buyer behavior—i.e., it clearly communicates the desired rent goal, from day 1, that a tenant(s) must achieve before a deal is actually consummated, the consummation of the deal could be more complex in nature than simply ‘automatically’ hitting the Tipping Point through the system processes. Many times, since the system provides for a passive and secondary marketing mechanism, the process will simply run itself to closing or end. However, there are several compelling use cases for this functionality. For instance, rental velocity could quickly approach to a value very close to the Tipping Point but stall and seemingly be not likely to achieve it. The Landlord/Sublandlord could be satisfied with everything else about the ‘deal’ and thereby want to ‘Call the Deal’ instead of losing it—especially in light of competitive spaces similarly outfitted and priced in the marketplace. As an alternative, perhaps the Landlord/Sublandlord could garner a tenant whose initial order is far below the Tipping Point, but it is otherwise known that the tenant is of very good credit and/or is very likely to soon after consummation rapidly expand into the balance of the space. The Landlord/Sublandlord would want to ‘Call the Deal’ in order to consummate a transaction with this tenant based on a more complex decision making process than what is automatically provided for in the system. That being said, the Tipping Point is fully modifiable at any time during the transaction process, so ‘Calling the Deal’ is possible but so is ‘Pushing the Deal’. Pushing is simply opposite of calling—the space is filling quickly and the Landlord/Sublandlord realizes that they have set the Tipping Point too low. They do not want orders to wane once the Tipping Point is reached, whereas the Landlord/Sublandlord may not want to change the pricing of each ‘seat’, they may wish to increase the rent that they wish to achieve overall for the space, the Tipping Point.

Offer Period is the length of time a listing is active and available for Lease on the market. When the Offer Period expires and the Tipping Point has not been met, the Lease deal will expire and be expunged from the marketplace. Subsequently, the Landlord may then choose to pull the deal completely, or re-offer (reactivate) by contacting the Salesforce or by selecting appropriate options automatically online.

Monthlies are month-to-month Tenants who may enter into month-to-month (or longer) leases in the remaining vacant space in certain ‘stabilized’ Premises that may or may not have previously been deals that have ‘tipped’. Monthlies may also apply to an ability to list space and deals in already established co-working environments such as Executive Office Suites and Co-Working/Incubator space, not requiring a Tipping Point. Monthlies may stay listed on the website on an ongoing basis after a Transaction occurs and will not be tied to a particular Offer Period. Monthlies use leftover space on a month per month or multi-month (with appropriate discounting) basis. In one exemplary embodiment, potential tenants may search for left over spaces and leases it on a month per month basis. A search specifically designed to search for these spaces may be performed and a different lease to cover the month to month arrangement may be signed. The balance of the space may or may not only be offered month-to-month, and it may be offered to the marketplace, only the existing tenants within a space, or both. For a deal originally 12 months, an ongoing deal (likely at a higher rent) would be advertised for the ‘remaining term’ (# months thru a certain date) on the original term. Therefore, 3 months in, they had ostensibly signing up for a 9 months.

Swaps are a mechanism whereby Tenants may trade Seat(s) between themselves during a Term to allow for expansion and contraction. This could be a separate destination page that Tenants and Landlords would have access to during a transaction process or leasing in order to facilitate Tenants posting desires to, and eventually transact a Swap. Swaps are easily facilitated through the use of congruent Lease agreements and the process of leasing in an exemplary embodiment.

Private Listings: in some cases, a Landlord/Sublandlord may want their listing to appear ‘off market’ and only be made available to a select group of people (these people could be users on the system or not, and may be limited to or otherwise filtered to groups of them within company, within the subject space (and/or nearby space), within a credit band, within a geographic area, within a certain industry or market segment, with a social grouping, etc.). Private Listings enable functionality to market a space directly to a select group by either a) sending an invite to log-in and directly be passed to the specific listing (if not already users), or b) push the listing to a user—say, a user in a listing that has a reservation, but there may be more vacant seats available that they could expand into (i.e. instead of Monthlies). In an exemplary embodiment, Private Listings cannot be searched or ‘seen’ by anyone whose login is not initially identified by the Landlord/Sublandlord. Private Listings are a powerful tool for a) offering expansion or re-offering current ‘seats’ for extension to tenants who already have ‘seats’ within a space (for instance, functionality would be easily utilized to allow tenants with complementary expansion/contraction needs to simply Swap their complementary reservations for similarly priced and located ‘seats’), b) offering Listings only to those of a certain caliber, credit, or relatedness to the desired tenant-base or even relatedness to Landlord/Sublandlord (i.e. offer a listing to only the Landlord/Sublandlord's contractors, affiliates, offer a listing only to ‘friends’ within an established social network, etc.), or c) simply exchange ‘seats’ reservation to reservation via a pre-populated pool of users (i.e., Landlord/Sublandlord A, Landlord/Sublandlord B, and Landlord/Sublandlord C all post ‘seats’ on the system and it is agreed that members of the organizations of A, B, and C may freely enter into and amongst each others' spaces, possibly by a ‘currency’ created by the amount of ‘seats’ each posts to the system that may be exchanged or otherwise traded/swapped/exchanged.

FUD is a ‘Full User Discount’. For example, if a group wants to lease 100% or very close to 100% of the Seats, or a significant portion/pre-defined Premises rather than Seats/Shares, they could get a discount on a per Seat basis/entire Premises rent. This would be pre-determined discount by Owner, advertised as a FUD on the Listing, and applied at Checkout. Moreover, seats may be grouped into sections as discussed above and the Owner may provide a discount on a per section basis. Alternatively, a new set of terms and conditions and process for leasing the space could be triggered altogether. This process could supersede any per-seat reservations automatically.

Passes: are a unit of one or more items other than seats/shares that is being leased or otherwise must be utilized, organized and potentially monetized. Passes are similar to licenses for other parts of the space or amenities that are available within the space. Passes are ways to ‘monetize’ things other than ‘seats’ within a leased space, but they should not be limited to things other than ‘seats’. For instance, passes could be one strategy to lease ‘sections’ of seats, or potentially to offer infinitely greater flexibility for pricing and utilizing ‘seats’ than simply reserving one seat per person for a month (i.e. an ability to offer a ‘flexible’ seat to be shared between users and companies on a monthly, weekly, daily basis). Passes may be complementary to, or actually represent the seats. By way of an example, passes are similar to membership, or ‘coupons’ that may be utilized to access amenities (including actual physical features and the use of them—hours of a shared conference room, rack of a server, administrative services, etc.). By way of another example, passes are fully modifiable leasing arrangements/memberships including access to ‘seats’ (i.e., a ‘Pass’, or membership, good for shared access to a specific section of seats, or even an entire space, during normal business hours M-F, expiring in one week). Passes may or may not be included in the Tipping Point, at Landlord/Sublandlord's choice, and often times will simply provide either additional monetization flexibility for a Landlord/Sublandlord or be utilized to control usage and utilization within (manage) a space for other components that there may be a limited quantity of (i.e., if the conference time that the reserved ‘seat’ comes with is not enough, the tenant can buy more hours via a Pass). Many times, Passes can and could be ‘geo-coded’—that is, they could appear similar to a seat on a Plan (different icon, color, etc. from ‘seats’)—this would be useful to allow a tenant to choose which conference room(s), (certain sizes and AV capabilities) they wish to buy extra access to versus another, or perhaps purchase ‘priority access’ to a particular lounge area nearby their reserved ‘seat(s)’. Alternatively, they may be ordered on subsequent webpages as part of the ‘checkout’ process, especially if they are not a physical part of the Premises—extra parking spaces, server rack(s), higher speed internet, etc.

Redemption: is a concept of use with respect to Passes. That is, once a certain type of Pass is purchased, it is up to the purchaser to use it—to utilize what's been paid for, or ‘lose’ it. This is particularly important for Passes for ‘places e.g., Conference rooms, which are limited in quantity and may have multiple tenants. In this way, similar to coupons, both those purchasing and those offering have a) control over usage volume via redemption, b) information about utilization and redemption through the redemption process, and c) may add more Passes to the system (and make more money) once redemption occurs. In an exemplary embodiment, the redemption of Passes purchased through the system will be integrated somehow into the physical space for redemption—whether through an office manager's ‘terminal’ connected to the system, or to physical terminals connected to the amenities which the Passes are for (an internet connected electronic device next to a conference room door that glows green when you enter the code that your Pass has generated).

### Overview of Leasing System According to Exemplary Embodiment

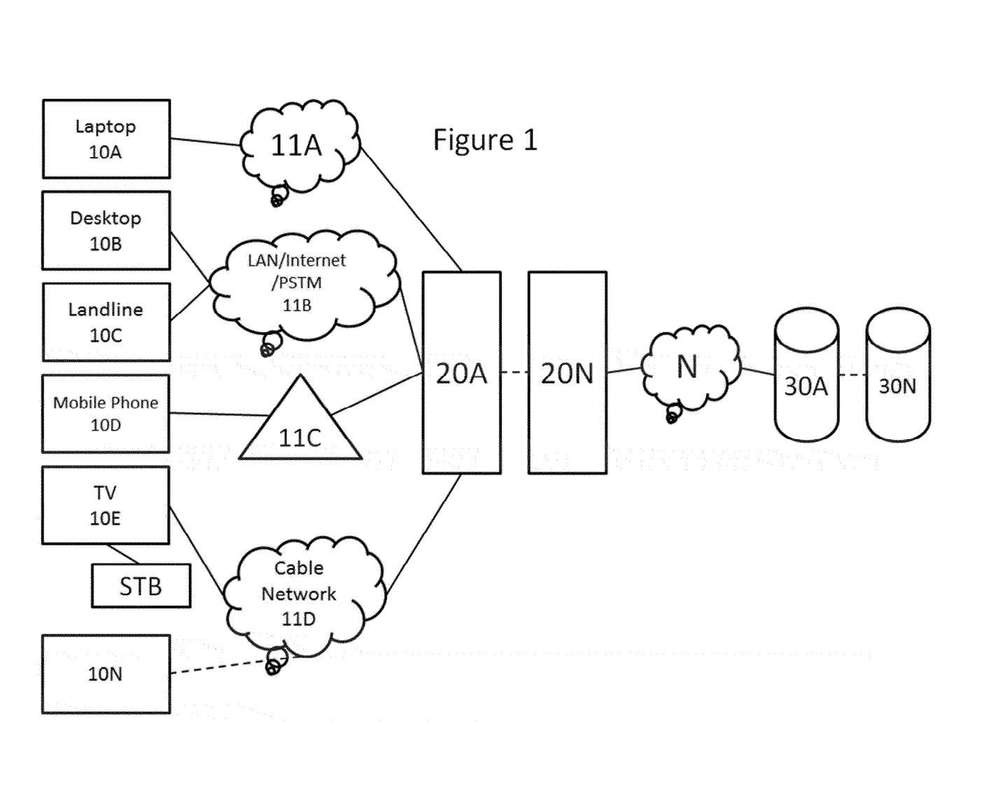

FIG. 1 is a block diagram illustrating a system for providing leasing related transactions according to an exemplary embodiment. The exemplary system includes one or more user devices 10a-10n. The user devices 10a-10n may be used by users (landlord, tenants and salesforce) to send data such as search requests, new listing generation requests, selected search results, purchase requests for one or more seats, etc. via a specific access point, base station, and so on. For example, a user device may be a laptop, a tablet, and/or a notebook 10A, a computer e.g., PC, 10B, a telephone 10C such as a LAN line telephone, a mobile terminal such as a smart phone 10D, and an IPTV 10E e.g., a TV with a set-top-box (STB). The user devices may have peripheral devices such as a display (e.g., a cathode ray tube (CRT), plasma display, or a liquid crystal display (LCD), a mouse, a keyboard, a remote control, a data source, and so on. The exemplary leasing system may further include one or more backend servers 20a-20n that process the requests of the users including landlords, potential and actual tenants, and salesforce.

The exemplary user devices 10a-10E and the exemplary servers 20A-20N may include a data bus or other communication mechanism for communicating information across and among various parts of the device/server and communication interfaces for communicating information outside the device/server, and a processor coupled with bus for processing information and performing other computational and control tasks, a volatile storage, such as a random access memory (RAM) or other dynamic storage device, coupled to the bus for storing various information as well as instructions to be executed by processor and a nonvolatile storage such as a read only memory (ROM or EPROM) or other static storage devices coupled to the bus for storing instructions for processor. A persistent storage device, such as a magnetic disk, optical disk, or solid-state flash memory device is provided and coupled to the bus for storing information and instructions. Each of the server 20A-20N may include a processor, an input/output unit, and a memory, and may optionally also include a display.

Separate databases (data source) 30a-30n may be provided for storing information related to the tenants, landlords, salesforce, and various transactions. These databases 30a-30n may include one or more memories and one or more physical interfaces to provide information via a network N, which may be wired or wireless network.

The user devices 10A-10E may be connected to servers 20A-20N via various different networks, which may include a wired or wireless network (optic, cables, etc.), a data network such as an Internet, a Public Switched Telephone Network, and so on. The user devices 10A-10E may have a communication interface, such as network interface card. The communication interface provides a two-way data communication coupling to a network link that is connected to a local network. For example, communication interface may be an integrated services digital network (ISDN) card or a modem to provide a data communication connection to a corresponding type of telephone line. As another example, communication interface may be a local area network interface card (LAN NIC) to provide a data communication connection to a compatible LAN. Wireless links such as 802.11a, 802.11b, 802.11g and Bluetooth may also be used.

For example, the user terminal 10a is a notebook, which is connected to the servers 20A-20N using a network 11a which may include wireless communication such as WIFI, Bluetooth, or via wired communication such a cable and a modem that connects the notebook to the Internet. The user terminal 10B is a PC and the user terminal 10C is a telephone that communicate with the servers 20A-20B using various types of networks 11B such as LAN connecting to Internet, Public Switched Telephone Network (PSTN), and so on. The user terminal 10D is a mobile terminal that communicates via base station 11C using a cellular network such as GSM, CDMA, and so on with the servers 20A-20N. The user terminal 10E may be a television such as an IPTV, which communicates with the servers using the cable network 11D and/or data network such as the Internet.

Networks 11A-11D may provide connections to the servers through local network and/or other network such as Internet. Additionally or alternatively, the user devices 10A-10E may connect to the networks 11A-11D through gateway/firewall where the network may be a wide-area or global network.

A leasing management system may be embodied as a software application according to an exemplary embodiment and may be stored on various computer-readable mediums. The term “computer-readable medium” as used herein refers to any medium that participates in the processes described above. The computer readable medium may be a computer readable signal medium or a computer readable storage medium.

A computer readable storage medium may be, for example, but not limited to, an electronic, optical, magnetic, electromagnetic, infrared, or semiconductor system, apparatus, or device, or any suitable combination of the foregoing. More specific examples (a non-exhaustive list) of the computer readable storage medium may include the following: a portable computer diskette such as a floppy disk or a flexible disk, magnetic medium, a hard disk, ROM, EPROM (flash), RAM or any other memory chip or cartridge, an optical fiber, a portable compact disc read-only memory (CD-ROM), any other optical medium, a tape, punchcards, papertape, an integrated circuit, any other physical medium with patterns of holes, or any other medium usable by a computer now known or heareinafter developed. A computer readable storage medium may be any tangible, non-transitory medium that can contain, or store a program for use by or in connection with an instruction execution system, apparatus, or device or data that is used in the program or the instructions execution system.

A computer readable signal medium may include a propagated data signal with computer readable program code embodied therein, for example, in a base band or as part of a carrier wave. Program code embodied on a computer readable signal medium may be transmitted using any appropriate medium, including but not limited to wireless, wire line, optical fiber cable, RF, etc. or any suitable combination of the foregoing.

Although the enabling software might be “written on” a diskette, “stored in” an integrated circuit, or “carried over” a communications circuit, it will be appreciated that, for the purposes of this application, the computer readable medium will be referred to as “including” the software. Thus, the term “including” is intended to encompass the above and all equivalent ways in which software is associated with a computer usable medium.

An illustrative, non-limiting embodiment is a leasing application that aggregates tenants to bid for one lease of a larger space. The software application can be delivered to the user via a web-based graphical user interface. The software application can also be deployed over a dedicated computer network (e.g., a LAN or a WAN), or via a stand-alone computer system for a particular company, such as an intranet installation, or by some other means. For simplicity and ease of discussion, various illustrative, non-limiting embodiments will be described with reference to an Internet/world wide web-based system, with the understanding that networks or communications systems similar to, but not identical with the Internet, may of course be used.

On a practical level, the software of the leasing application enables the computer system to perform the operations described in further detail below and may be supplied on any one of a variety of media. Furthermore, the actual implementation of the approach and operations of exemplary embodiments are actually statements written in a programming language. Such programming language statements, when executed by a computer, cause the computer to act in accordance with the particular content of the statements. Furthermore, the software that enables a computer system to act in accordance with an exemplary embodiment may be provided in any number of forms including, but not limited to, original source code, assembly code, object code, machine language, compressed or encrypted versions of the foregoing, and any and all equivalents.

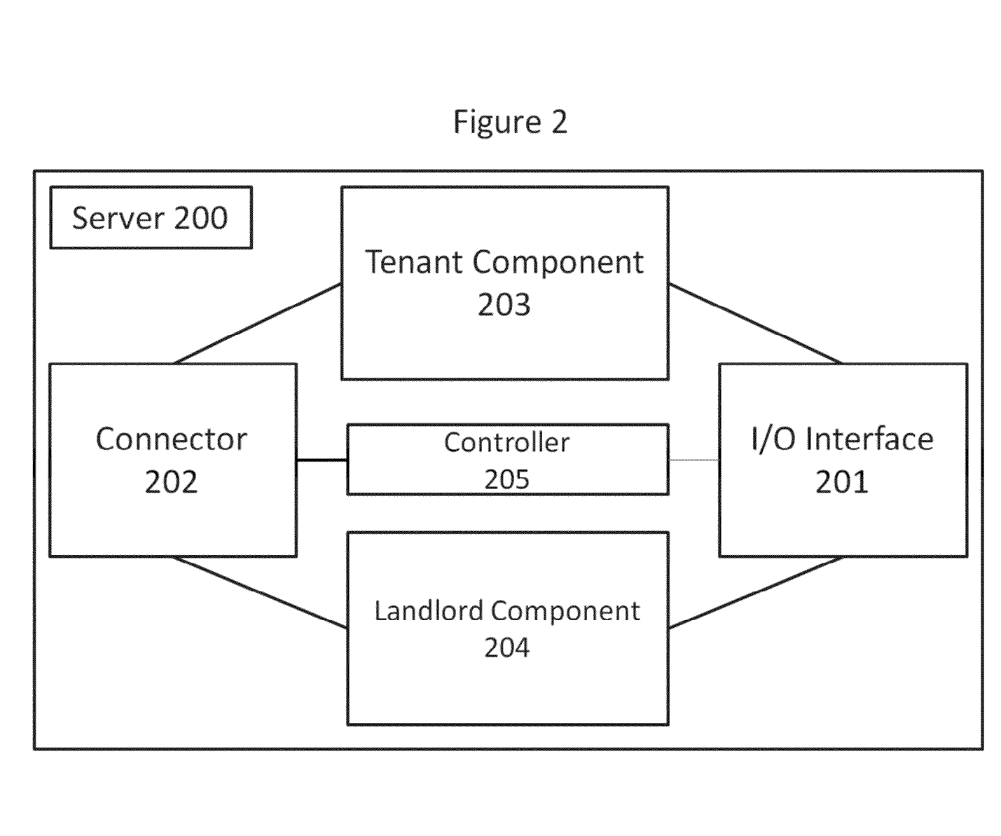

The leasing application may be embodied as online software accessible through the web and/or mobile device(s) that allows users of space (“Tenants”) to search for and transact leases for space and purchase of passes with space owners (“Landlords/Sublandlords”). In an exemplary embodiment, individual users (individual persons or companies) gain access to and transact leases in spaces and passes that they may not have the ability to transact a lease/license for individually, but can transact a lease/license for in the aggregate. FIG. 2 is a bock diagram illustrating a server apparatus for facilitating lease related transactions according to an exemplary embodiment.

In an exemplary embodiment, the server apparatus 200, shown in FIG. 2, includes at least a memory and a processor. The server apparatus 200 includes an input/output (I/O) interface 201 that receives a message from a user and parses it to determine which component should process the request in the message (tenant component 203 and/or landlord component 204). If the message is from a tenant or potential tenant, the message may be handled by the tenant component 203. If the message is from a landlord or potential landlord, the message may be handled by the landlord component 204. That is, the I/O interface 201 forwards the data obtained from the parsed message to a particular component.

The tenant component 203 handles all tenant related requests such as tenant requests for searches, tenant selections of a deal or deals, and tenant post processing after the deal is obtained including but not limited to processing payments, receiving a signed lease, and so on.

The landlord component handles all transaction related to a landlord including generating a new deal, accepting a deal, and post processing. Both components are connected to a connector 202 to send and receive data from various data sources such as the databases 30A-30N described with reference to FIG. 1. Further these components may send data back to the user (user device) via I/O interface 201.

The landlord component may help generate a posting by providing useful information for the landlord via questions for example that would emphasize desired characteristics for the landlord. Based on location, it may suggest to the landlord what tenants are looking for. For example, for an office in Alexandria, it may ask the landlord if the Office has internet, nice view, over four WLAN points, whether it is within 4 miles from a Governmental Agency such as the USPTO. Further, the system may guide the landlord to generate passes. For example, the system may ask the landlord a series of questions about the amenities available and then apply the acquired use statistics to generate suggested passes to the landlord. For example, small tenants use a conference room on average four hours a week. The passes for the conference room may then be generated for 4 hours a week. Further, if it determined by the system that the peak time for the conference room is Tuesday around 11 am-3 pm, then the system may suggest a higher price for the passes to the conference room during peak hours. Similarly, the system may suggest a discounted price for the conference room after 6:30 pm. The landlord may then approved, modify, or delete the suggested passes. These questions for the space and/or for the passes are automatically generated by the system based on statics gathered from the tenants. As such, the automated system will guide the landlord to provide a most attractive advertising/posting for the area.

Moreover, the automated system can show the landlords various charts, graphs, interactive maps, heat map, and so on. These charts and/or graphs can be classified by feature, price, by a combination of features based on user selection of a particular filters. For example, the landlord may request a history of rented offices (for a property his size—filter 1) for a specified/predetermined time period (filter 2) with features A, B, and C (filter 3 such as offices with internet, fully furnished) for a price (filter 4) at a location (filter 5) can be set in radius, etc. The landlord may also adjust the format in which the output is received e.g., via a chart, a graph, a cluster on a map, a listing, and so on. By evaluating these listings, the landlord may determine how to make his offer more attractive, how to price the offer and so on.

Moreover, the leasing system may allow the landlord to view output in various formats as it relates to the tenants. That is, the tenants may be classified/filtered for the landlord with respect to the location desired, price, features, time, credibility (e.g., credit score) and so on.

Based on these various results, the landlord may modify his offer or generate an offer with the desired features.

Analogous features are available for tenants. For example, the tenant may input desired monthly rent price and the features he or she desires, and the system may evaluate availability and even whether he or she can obtain such a lease based on the statics gathered from the landlord. That is, even if a particular posting is not currently available, it can help the tenant to determine if he should wait for such a posting or lower his or her desires. For example, the leasing system can show the tenants various charts, graphs, and so on. These charts and/or graphs can be classified by feature, price, by a combination of features based on user selection of a particular filters. Moreover, in an exemplary embodiment, the leasing system can further provide social filters i.e., showing tenants within a particular industry field or may be showing potential clients, competitors, acquaintances that have leased in the vicinity. Further, social filter may be added for the landlord e.g., landlords that the tenant worked with in the past. As another example or in addition, the tenant may not see a good offer at this time and may request a history of rented offices (for his size—filter 1) for a specified/predetermined time period (filter 2) with features A, B, and C (filter 3 such as offices with internet, fully furnished) for price (filter 4) at a location (filter 5) can be set in radius, etc. The tenant may further set the format for the output e.g. via a chart, via a graph, via a cluster on a map, via a listing, and so on.

Further, although an exemplary embodiment describes displaying the output results. This is provided by way of an example only. The results may be stored on a memory, directly printed, or transmitted to another device. For example, the results may be provided by way of an SMS message, an email, and so on. This may be handled via the I/O interface 201, which may have a number of sub-interfaces for transmitting data via various different channels.

A tenant component 203 and a landlord component 204 may be software, hardware, or a combination thereof. For example, a tenant component 203 and/or the landlord component 204 may be an integrated circuit such as field programmable gate array (FPGA) with software executed thereon.

A controller 205 may handle the operations of the server apparatus 200. The controller may forward data to various components, may instruct various components and control their operations.

### Exemplary Landlord Component

A landlord component is designed to handle actions taken by the landlord or potential landlord according to an exemplary embodiment. The landlord component includes a generator which is configured to generate new listings, an editor configured to edit existing listing, and a remover configured to delete unwanted or expired listings. The landlord component further includes an archive, which may categorize and store old listings and all or some of the related metadata associated with the listings. The landlord component may further handle user requests related to pending reservations from potential tenants, listing postings and repostings. The landlord component may further handle providing statistical analysis of tenants and other spaces. The landlord component is described in further detail below.

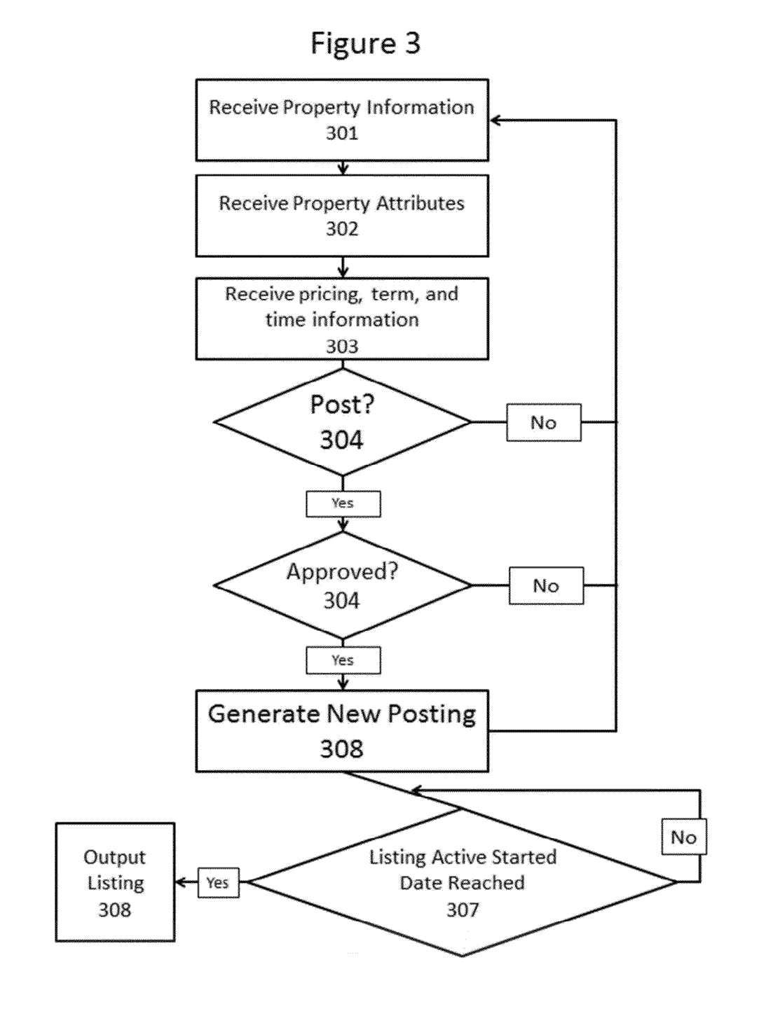

FIG. 3 is a flow chart illustrating a method of generating a lease related listing according to an exemplary embodiment.

As shown in FIG. 3, when the user such as a landlord decides to generate a new listing, he or she must first log into the system. Login may include a name and a password as is known in the art. Once the user logs into the system, the user may then select an option of “list your space” e.g., to generate a new listing. The user is then provided with a user interface to generate the listing. The user inputs basic property information such as an address, a property name, a floor, total square feet, brief description, and so on, which is then transmitted to the server apparatus 200 (described with reference to FIG. 2). In operation 301, the system receives property information that was provided by the user.

Next, the user inputs attribute information for the space. That is, the user may input characteristics of the space such as whether the layout is open space or office intensive. The user may further specify type of space e.g., a direct lease, a sublease, a co-working type of lease or executive center/business center that is being leased. The user may further indicate features or amenities such as conference rooms, copiers, printers, storages, equipment (phone and data), server racks, fitness center availability, furnished/unfurnished, type of furniture includes, availability of a kitchen area, availability of management/receptionist, availability of an outdoor area (balcony/roof top/deck), availability of parking (reserved, general, and so on), number of spaces, services included (phone, internet, mail services), availability of signages (type, size, location), utilities (included or not). For each attribute/characteristic, the user may provide additional description as well as to indicate if this attribute is included in the rent, is available for an additional cost, or is not available. Further, in an exemplary embodiment, the user may indicate that a particular feature is to be provided via passes, the user may also indicate that a particular feature may be provided for free for a first predetermined period of time and then purchased via a pass for additional period of time. This is provided by way of an example and not by way of a limitation. The features may be linked to one or more seats or may be leased independent from seats via passes. Further, a combination of the two is possible. A particular feature may be linked to one or more seats for a first predetermined period of time e.g., Monday-Friday, 9 am to 5 pm and this same feature may then be available via passes for a second predetermined period of time e.g., Monday-Friday before 9 am or after 5 pm. Each pass may be for an hour or two hours of conference room use. The input characteristics/attributes are transmitted to the server apparatus. In operation 302, the input attributes/characteristics of the property are received.

Next, the user may input minimum rent amount needed to rent this space i.e., the Tipping Point. That is, the user may input what is the minimum amount of rent to be received in order to rent the space. The user may also indicate the number of months deposit required (one month, two months, etc.). The user may further input earliest and latest move-in Dates available e.g., lease must start between Sep. 1-Sep. 30, 2013, and may specify whether the move-out/expiration date is ‘fixed’ or not—that is, whether all tenants in a single listing are required to have a lease that expires on the same day, or whether there may be variance (based on a user indicated minimum acceptable lease term from the move-in date and an ‘outside’ date for the longest lease term acceptable). The user will further input the expiration date for the lease and the listing active dates. For example, list my space from Jun. 1, 2013-Aug. 1, 2013. That is, the user may specify the dates the property is to stay an active listing that can be selected by potential tenants. The user may further specify whether the listing is to be private i.e., available to only selected potential tenants. For example, the user may wish to provide the listing to all existing tenants first as a courtesy and then open it for public bidding (whatever is left) in a week or so. The user may further upload the license/lease agreement to be e-signed by the potential tenants, the user may further upload any media such as multiple images, videos of the space, and so on. In addition, the user may offer tenant insurance to potential tenants and provide it with the listing.

An ability to provide insurance as part of the transaction flow for these leasing of seats and/or passes is one of a unique features of an exemplary embodiment. In an exemplary embodiment, the leasing transactions can be completed online at a speed that surpasses traditional procedure in efficiencies. In an exemplary embodiment, the landlord participates in tenant aggregation, which allows for the insurance. That is, an insurance may be difficult to obtain for a few seats or for utilizing a space for a period of time less than a full day for example. Also, the insurance may be cost prohibitive for the limited amount of time of space use. However, in an exemplary embodiment, by aggregating the leases, a new insurance product is provided. The cost of this new insurance product is allocated/divided among tenants based on a number of purchased seats and/or seat types, and/or number of passes, and so on. Landlords comply with lender and other stakeholder legal requirements regarding tenant insurance etc., while leasing space to a number of small and individual tenants.

The user may further upload a floor plan to be used for dividing the space into seats and sections and Premises.

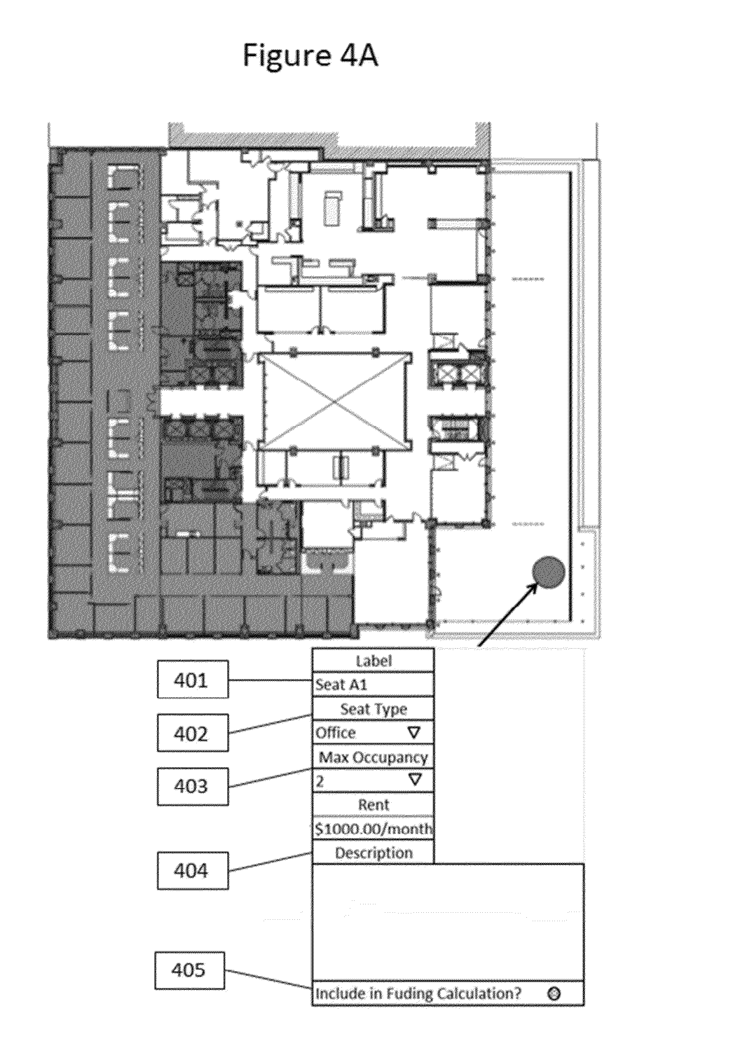

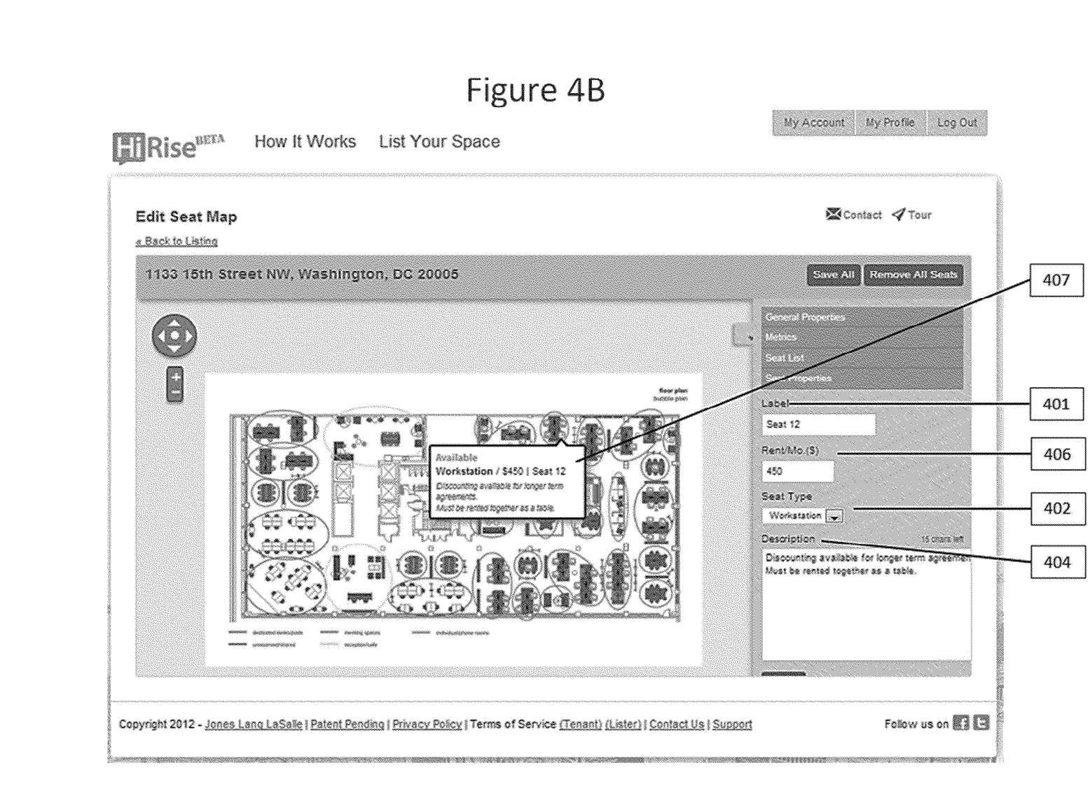

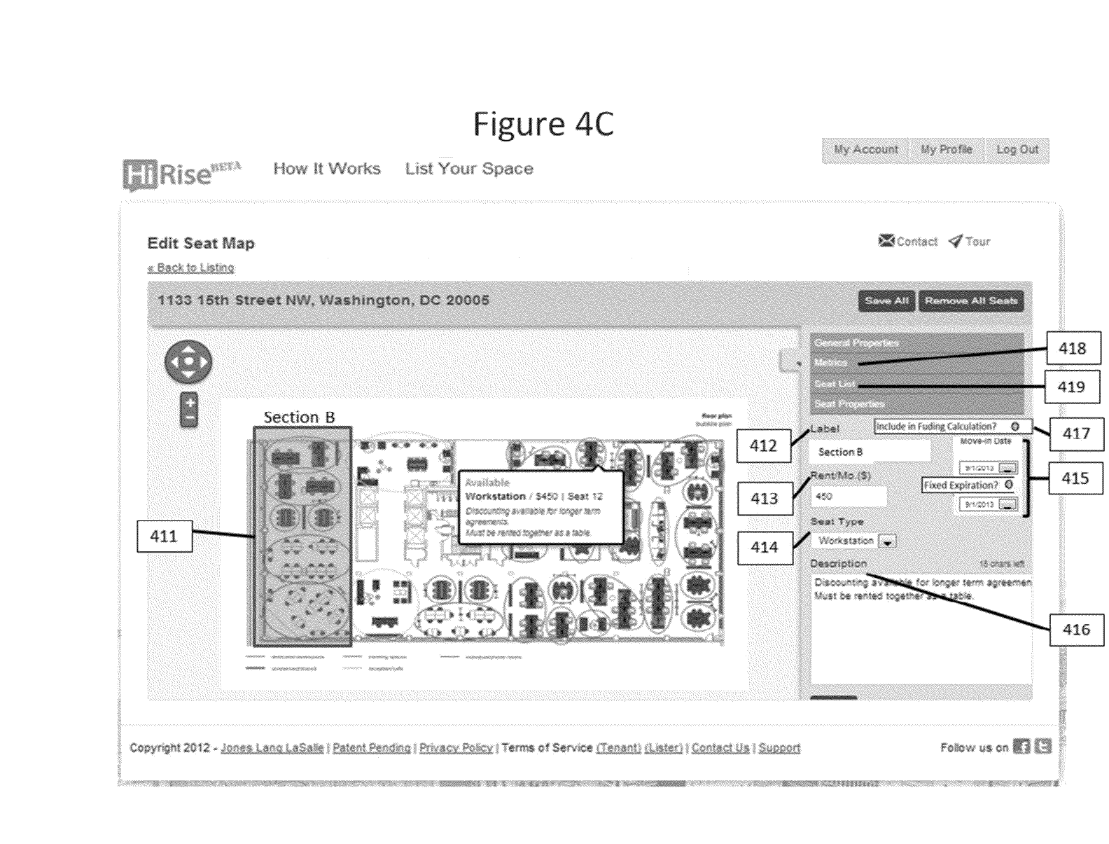

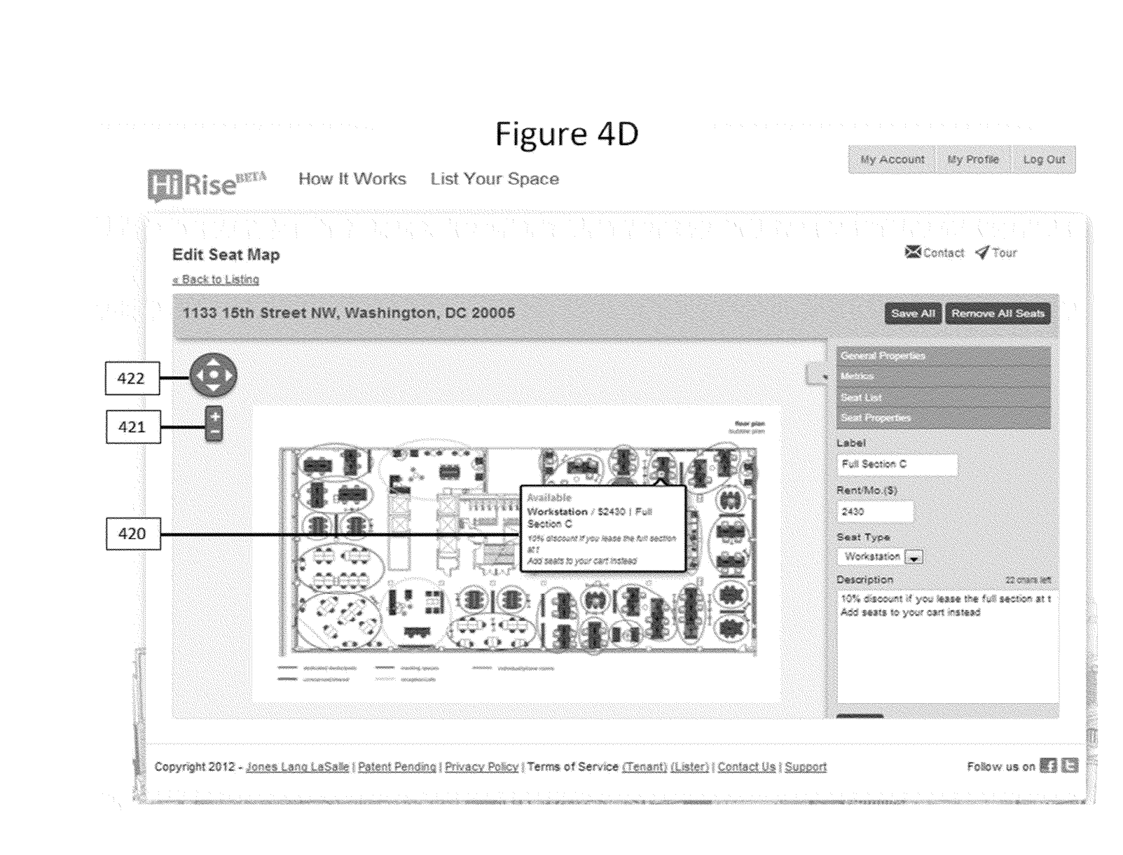

FIG. 4A is a view illustrating a user interface for generating seats for a space according to an exemplary embodiment. For example, as shown in FIG. 4A, once the user selects a space on the uploaded floor plan, the user may then specify metrics (size of the seat), number of people it seats (if more than one), attach media such as pictures to the seat, and so on. The user may input a seat name (“Seat A”)—label 401, the user may then input a seat type 402 (“Office, Workstation(s), Other”), dates 403, which may include range for the move in dates, and expiration date for the least. Additionally, the user may input whether the expiration date is fixed or not.

The user may add additional description about a particular seat 404 e.g., the room has a projector, monthly pass to the fitness center, and so on. In an exemplary embodiment, the user may divide commodities to various seats and indicate it on the seating map. For example, the user may allocate one parking space to seat A, two parking spaces to seat B, a conference room to seat C or a number of hours a month that conference room may be used by a particular seat, and so on. Similarly, equipment such as printers, copiers, telephones may be shared among seats or allocated to various seats. They user may easily create a custom seating map on the fly, i.e., in real time. The seating map may be updated at any time. Pricing changes for seats, shares and Premises may be administered and changed on the fly in real time, or they may, at the user's election, be powered and automatically adjusted in real time by an algorithm(s) based on system data on leasing history, current supply and demand, etc.

Further the user may indicate which seat is to be included in the calculation for the tipping point (minimum rent required) 405. That is, although the seats will be rented only if a tipping point is reached, renting some seats may not contribute toward reaching the tipping point e.g., renting a conference room, or a Pass to a certain amenity.

The user may copy attributes of a particular seat so that it can be applied to another seat without having to retype all the characteristics. The user may delete a seat, may save all seats or select a portion to be saved. Once the user selects to save the generated seat chart, in one exemplary embodiment, the generated seat chart is saved in the system. In another exemplary embodiment, the various input attributes of each seat are reviewed and the seat chart is automatically redrawn by the system based on input characteristics. For example, the size of the seat is varied based on its actual size. As another example, the shape of the seat is varied based on the seat type e.g., triangular shape for other, square for an office, and a circle for a workstation. Further, various color coding schemes and labels are provided in exemplary embodiments. For example, the seats maybe color coded based on their availability dates, based on price, based on whether they are included in the funding calculations, and so on. Additional labels may be provided to indicate which ones are already reserved (R), for which ones reservation is pending (P), and which ones are available (A). In an alternative exemplary embodiment, available seats may be indicated in green, reserved seats in red, and pending seats in yellow and labels may be provided for the price ($$$—for expensive seats, $$—for medium cost seats, and $—for cheap seats).

FIG. 4B is a view illustrating a user interface for generating a seat according to another exemplary embodiment. As shown in FIG. 4B, the user may further specify rent amount 406 and the seat may be displayed with a label 407. The label may include the status of the seat (available/reserved/pending) and its type, label, rent amount and so on. The user may easily select attributes and media to be displayed in the label 407. Accordingly, when a potential tenant hovers over the seat, the label will be shown with the user selected attributes. The potential tenant may further select the seat (e.g., click on the seat) to see additional details.

FIG. 4C is a view illustrating a user interface for generating sections with more than one seat for a space according to an exemplary embodiment. In an exemplary embodiment, the user may further generate sections 411, as shown in FIG. 4C. That is, the user may further group seats into sections via a drag and drop technique, for example, or via draw over the map technique provided by the system. In an exemplary embodiment, in the drag and drop technique, the user may click on a number of seats sequentially, selecting these seats, and then click create a section option e.g., button, and a section will be generated. In an exemplary embodiment, in the draw over the map technique, the user may simply draw a box (circle, etc.) around the area for which a section is to be created. Accordingly, all seats within the drawn box will be included in the section automatically by the system. In yet another exemplary embodiment, not only can multiple seats be selected as a section, but such functionality can be used as an ‘avenue’ to lease sections and/or premises in a more ‘traditional’ manner. The user instigated the search for a number of the seats, found a multitude of them that worked, selected them in a location that was appropriate, and was then contacted by the lister for a least on the premises or a portion thereof via a traditional leasing model.

In an exemplary embodiment, a tenant user selects and ‘drags over’, a section or entire premises. The seating chart may indicate ‘click and drag’ over an area to unlock an entire section. The system then logs this and a pop-up says ‘interested in the entire selected space?’ The user may confirm e.g., click yes and the lister is then contacted via email or other ways to work out a price and other leasing terms. In an exemplary embodiment, clicking and dragging replaces click and seat selection method for premises versus seats. Of course, one of ordinary skill in the art would readily realize that this is provided by way of an example and not by way of a limitation. One of ordinary skill in the art would readily recognize that both techniques may be applied. For example, both strategies may be combined i.e., click and drag desired seats into the cart (which may unlock volume pricing rules) for them and after a certain number of seats are selected e.g., a predetermined threshold may be set by the user. A pop up screen may be provided that will inquire whether the user would like to keep all of these seats in their cart or be contacted for special offers for this Premises/Section. In an exemplary embodiment, the sections may be custom created by a user. That is, based on a lister preset threshold value, the user may create a custom section with a volume pricing discount by selecting various seats on the floor map.

According to an exemplary embodiment, the system may automatically combine elements of the seats to generate attributes of the section. According to another exemplary embodiment, the user may input attributes of the section separately. Attributes for the section may be similar to attributes for the seat and may include additional attributes. For example, the landlord component may calculate the size for the section by aggregating the size of each seat included in the section to provide the size of the entire section (metrics) 418. The landlord component may further generate a list for the seats to be included in the section and output the list upon a user selection (seat list 419). The user may further drill down to a particular description of each seat by selecting a seat in the list. The user may provide a name for the section 412 (“Full Section B”). The user may further specify rent amount for the entire section 413 through user specified ‘rules’ or other pricing tools. The rent amount may be calculated automatically by the system by combining rent amount of individual seats. The system may further apply any discount that may be specified in the description for the section 416. For example, the system may parse the description 416 to obtain the % of the discount and apply it to the total price. Accordingly, the field 413 may be auto-populated with the discounted price for the section. The user may further specify section type 414. Section types may include workstations only, offices only, mix of workstations and offices, and other. Similarly dates may be specified in fields 415. It is noted that in an exemplary embodiment, dates for the section may vary from the dates provided for the individual seats by receiving user input. In yet another exemplary embodiment, the dates may be automatically adjusted by the system based on the dates of individual seats e.g., earliest move in date (parse all seats and select the latest “earliest move in date” among all seats and use this as the earliest move in date for the section). The system may further apply any discount that may be specified in the description for the section 416 as such relates to lease Term (i.e., longer lease terms would effectuate discounting to a shorter-lease Term based on original pricing through user-specified ‘rules’ or other pricing tools). Similar calculations may be performed for other dates. Further, in an exemplary embodiment, additional fields may be provided to specify a number of workstations, a number of offices included in the section.

In an exemplary embodiment, the user may further specify whether Section B is to be included toward Funding calculations 417. By way of an example, some individual seats within the section may be excluded from the funding calculations but yet the section as a whole may be included. The system may automatically determine whether to include the section toward funding based on various criteria, which may be specified by the user. For example, if the price is above $2,000.00 a month or is otherwise greater than the previous ‘orders’ for the seats within the section, include in the funding calculation, potentially even in lieu of the individual orders that had previously come in for the individual seats. In an exemplary embodiment, the user may manually indicate if the section is included.

The user may copy attributes of a particular section so that it can be applied to another section without having to retype all the characteristics. The user may delete a section, may save all sections or select only some of the sections to be saved. Once the user selects to save the generated seat chart, in one exemplary embodiment, the generated seat chart is saved in the system. In another exemplary embodiment, the various input attributes of each seat and section are reviewed and the seat chart is automatically redrawn by the system based on input characteristics. For example, the size of the seat or section is varied based on its actual size. As another example, the shape of the section is varied based on the section type e.g., triangular shape for a mixed section, square for an offices exclusive section, and a circle for a workstations exclusive section. In an exemplary embodiment, the seat may be drawn with a bold solid line and the section may be drawn with a dotted line or shaded area/‘layer’. The user may set filters such that only sections are visible without the individual seats, or alternatively sections could be another ‘layer’ on the plan. Various color coding schemes and labels are provided for the sections in exemplary embodiments. For example, the sections maybe color coded based on their availability dates, based on price, based on whether they are included in the funding calculations, and so on. Additional labels may be provided to indicate which ones are already reserved (R), for which ones reservation is pending (P), and which ones are available (A). In an alternative exemplary embodiment, available sections may be indicated in green, reserved seats in red, and pending seats in yellow and labels may be provided for the price ($$$—for expensive sections, $$—for medium cost sections, and $—for cheap sections). In an exemplary embodiment, each section may be provided with a numeric reference label, which would indicate number of seats in each section.

FIG. 4D is a view illustrating a user interface for generating a section according to yet another exemplary embodiment. As shown in FIG. 4D, the user may further provide a label 420 specific to the section. The label 420 may include the status of the section (available/reserved/pending) and its type, label name, rent amount, discount provided, associated media/images and so on. The user may easily select attributes to be displayed in the label 420. Accordingly, when a potential tenant hovers over the section, the label 420 will be shown with the user selected attributes. The potential tenant may further select the section (e.g., click on the section) to see additional details. The user may further zoom in or zoom out in the seating map using keys 421, the user may further scroll through the seating map using keys 422.

In addition, the system may also generate passes either during the generation of seats and section and/or before or after. By way of an example, the user may select a conference room and select generate passes. The user may then provide a label name, price for the pass, number of passes to be generated and duration. Duration may vary depending on a type of pass. For example, if the user selects a pass of a parking type, the parking pass may be hourly, daily, weekly, monthly, and so on. If the pass type is a server rack, the duration may be weekly, monthly or maybe even annual. On the other hand, if the pass type is a conference room, the duration may be hourly. In addition to duration, a specific designated date and time may be provided. The system may further allow the user to link one or more of the generated passes to one or more seats or sections and to indicate whether it will cost additional money if selected or included as part of the seat. The passes may also be shape and color coded. The exemplary system may provide the passes as a third, separate layer on the seat map. In another exemplary embodiment, the passes may be provided on the seat map together with the sections and seats but in a specific shape and/or color. Further, in an exemplary embodiment, the passes may or may not be included in the calculating of the tipping point.

Once the seating map is generated, the user may transmit the time, price, and terms information to the system. The system receives the pricing, terms, and time information in operation 303.

In an exemplary embodiment, it is indicated that the data is received in various operations. This is provided by way of an example only and not by way of a limitation. In other exemplary embodiments, operations 301-304 may be combined into one operation such that all input information is received together after the potential landlord indicates that he wants to lease the space.

In operation 304, the user selects to post the listing and the system receives information whether the listing is to be posted. If the listing is not posted, the user may continue to edit, revise, or start a new listing. Information changed, added, and/or deleted may be received by the system one by one as indicated in FIG. 3 or all together once a posting is made.

In an exemplary embodiment, once a posting is made, it is optionally transmitted for approval to salesforce. In operation 305, if the salesforce does not approve the listing, it is returned to the user with comments for further editing. For example, the salesforce may indicate that the user needs to provide an image of the property or upload a lease agreement, etc. In operation 305, if the salesforce approves the listing, a new posting is generated in operation 306. The operations involving a salesforce is provided by way of an example only. In yet another exemplary embodiment, the salesforce is omitted and the system generates and posts the listing without any involvement from the salesforce personnel. In an exemplary embodiment, the system omits operation 305 shown in FIG. 3. In operation 307, the system checks if the start date for the listing being provided for bidding is reached. Once the start date is reached (Yes in operation 307), the listing is posted for public viewing and bidding, in operation 308.

In an exemplary embodiment, a new listing may be stored in a data source and linked to the respective user. Throughout various operations in the process e.g., operations 305-306, the user may receive email, SMS, and so on informing him or her of various operations. The information may be stored, printed, or displayed to the user in various stages of the above-noted exemplary process.

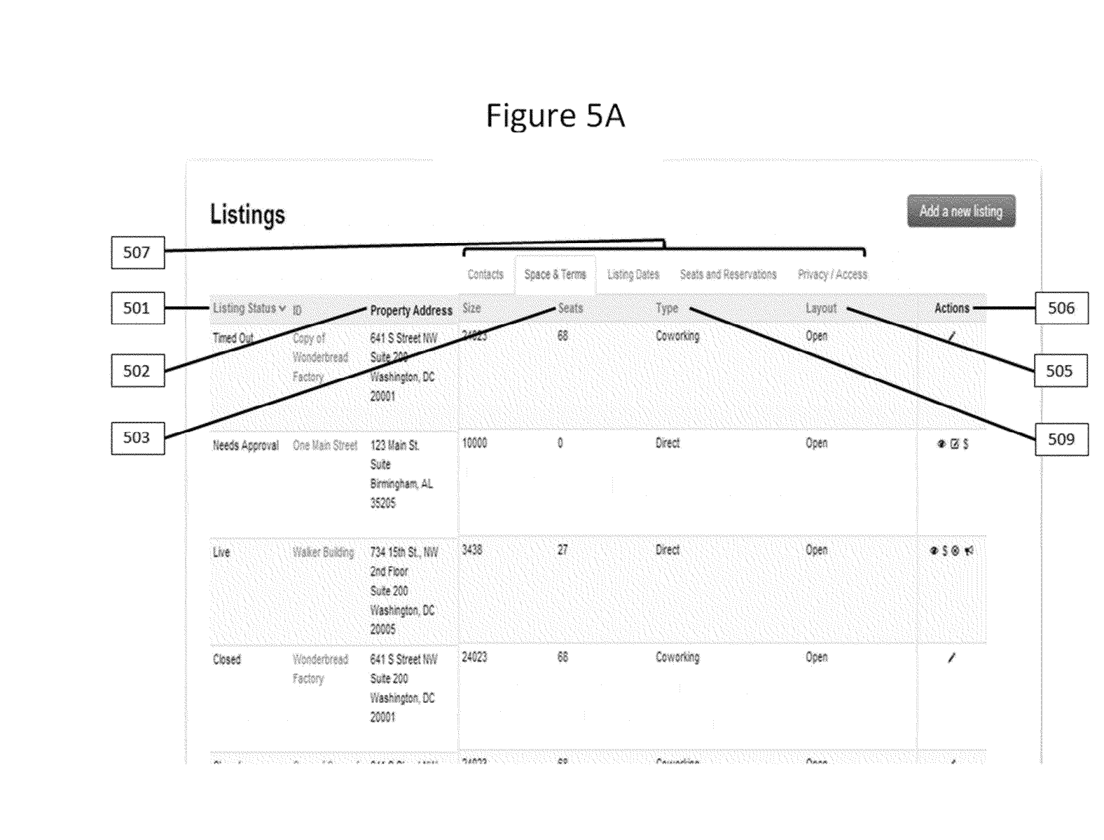

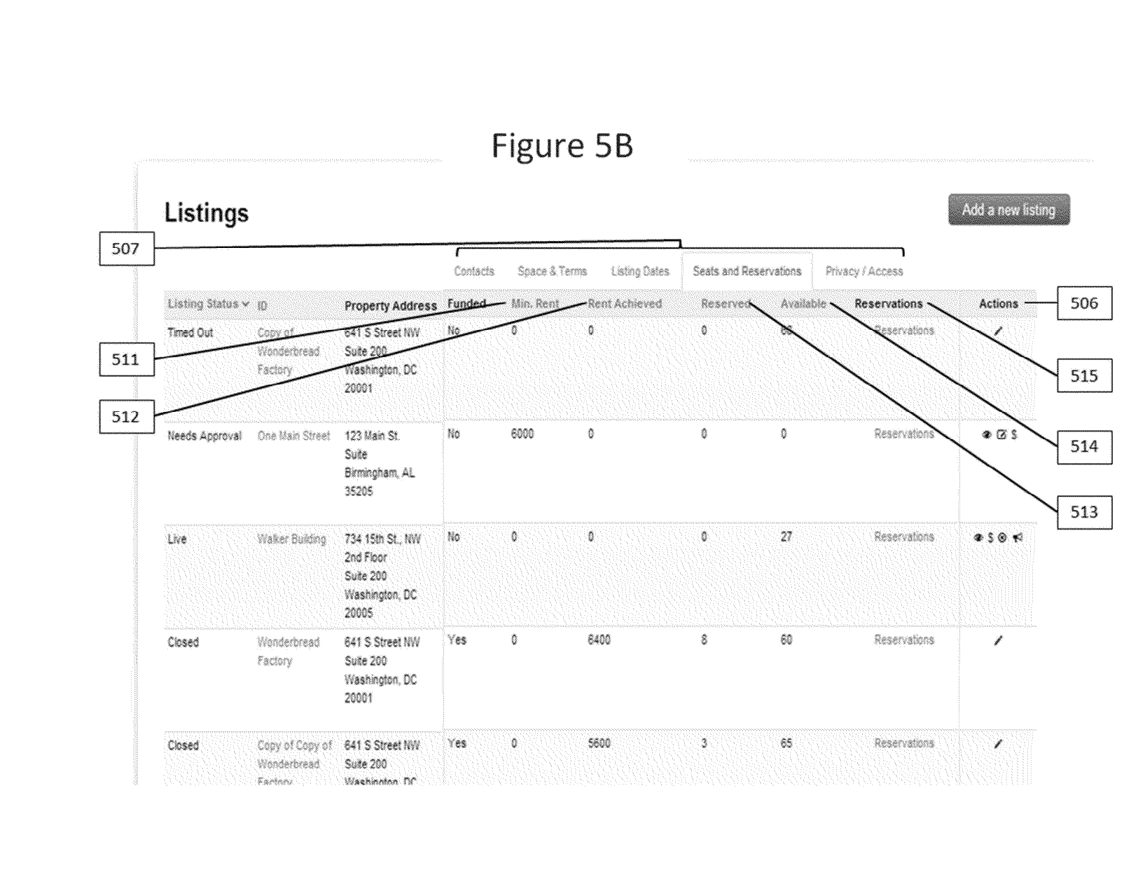

FIGS. 5A and B are views illustrating user interfaces for managing listings of a user according to an exemplary embodiment. In an exemplary embodiment, a user may manage all his or her listings together in a form of a list. For each listing, the user may view status of the listing 501 (active, inactive), property address 502, owner, salesforce (lister, broker, and their contact information) and available actions 506 for the listing. If a listing is active, the user may be provided with an option to deactivate the listing or restart the listing. On the other hand, if the listing is inactive, the user may have the actions of editing, previewing, or submitting for approval. By navigating various options e.g. which may be provided via tabs 507, the user may quickly view various information about the listing including total number of seats 503, type of lease (direct, sub-lease, etc.) 504, and the layout of the space 505. By navigating various options 507, the user may view seats and reservations for a particular space. For example, the user may view the set tipping point 511 (shown in FIG. 5B), total rent obtained thus far 512. In an exemplary embodiment, the system will show reserved seats 513 (discussed in greater detail below) and seats available 514. The system may further show number of pending reservations (not shown). The user may select a particular field 513-514 to view a list of reservations that were made and/or individual seats. The system may further combine rent amount to be received from the reserved seats and provide the total amount to the user 512. For each listing, listing dates, move in dates, expiration dates may be provided. The user may further drill down the menu to approve or decline potential tenants (reservations that are pending approval). In an exemplary embodiment, for each active listing, the user must approve all potential reservations. That is, the user reviews tenant information and approves or declines the reservation. If the reservation is declined, the seat/section is returned to available status. If the reservation is accepted, the seat/section's status becomes reserved and it is aggregated to the tipping point, if applicable.

In an exemplary embodiment, the listings may further provide a column for passes that are reserved (if this option is included for the passes), available, and are purchased. In an exemplary embodiment, a column may be provided for all available passes and all purchased passes. When the user selects one of the passes column, a new screen may be provided, in which passes are listed by pass types and for each pass type, number of available passes, number of reserved passes, number of purchased passes, and number of passes awaiting approval may be provided. Calendaring, orphaning (distribution to and amongst other users in the system, or their invitees and guests) of passes and other scheduling tools may be included. This is provided by way of an example and not by way of a limitation.

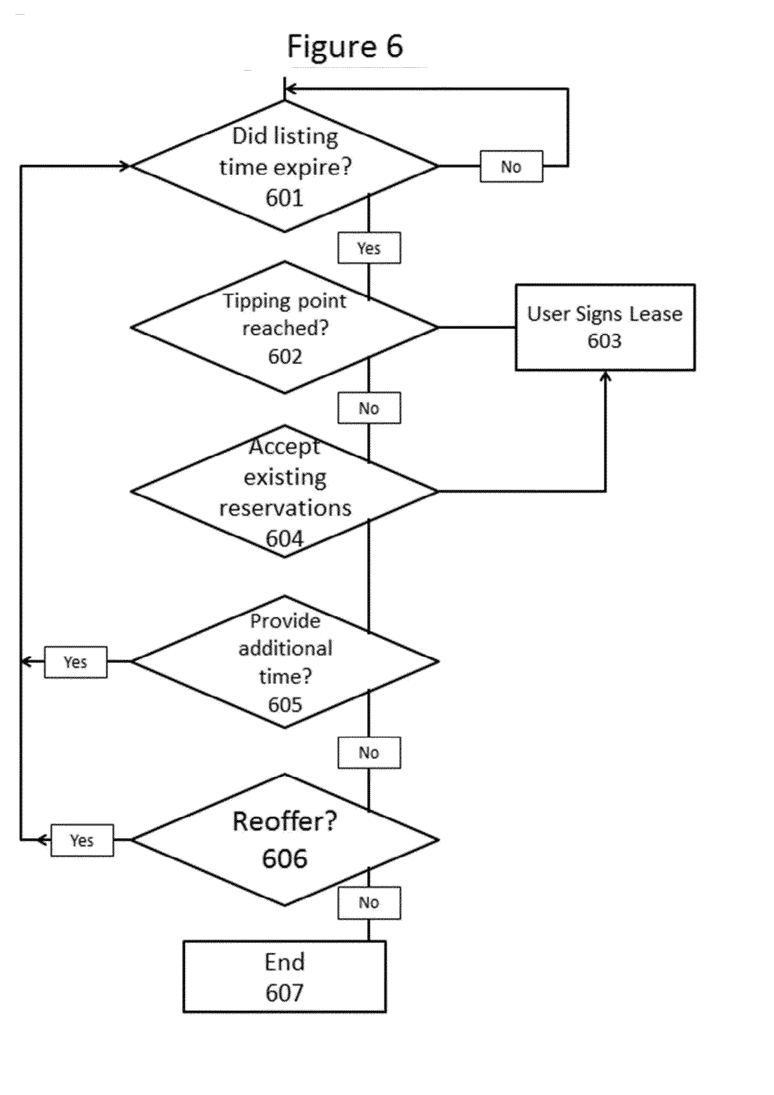

FIG. 6 is a flow chart illustrating a method of leasing a space according to an exemplary embodiment.

In FIG. 6, a method of leasing a space once the listing time expired is described according to an exemplary embodiment. In operation 601, a check is performed to determine whether the listing time expired. If the listing time did not expire (No—Operation 601), the system continues to wait until the active listing time expires. Once the active listing time expired (Yes—Operation 601), the system checks whether the tipping point has been reached in operation 602. The tipping point indicates that the user accepted a predetermined number of reservations whose combined/aggregated rent amount is equal to or greater than the minimum rent the user needs to obtain for the place. If the tipping point is reached, lease agreement is deemed counter-signed and accepted and the approved tenants and all parties are notified that a legally binding contract was made, in operation 603.

If the tipping point is not reached in operation 602, the user has the option to accept the existing reservations despite the fact that the tipping point was not reached in operation 604 by ‘calling’ the deal at any point in time while the listing is active. That is, in an exemplary embodiment, the user may “Call the Deal” at any point in time. If the Deal is called during an active listing, the flag is set indicating that the Tipping point has been reached. The listing may continue to be active until the time expires. If the Call the Deal is selected after the listing time expires, the system assumes that the tipping point has been reached in operation 602 and proceeds to operation 603, described below. Moreover, in an exemplary embodiment, the tipping point may be not reached when amount of rent collected from existing reservations is below the minimum rent amount set by the user. However, the user may decide to Call the Deal i.e., accept the existing reservations, and report the remaining seats as a new listing. If the existing reservations are accepted, the user signs the lease and the parties are notified that a legally binding contract was made, in operation 603.

If the user decides not to accept existing reservations in operation 604, the user may decide to provide additional time to tenants, in operation 605. If the user decides to provide the tenants with additional time, the process returns to operation 601. On the other hand, the user does not want to provide the tenants with more time, the user may reoffer the space in operation 606. That is, the user may vary certain terms or conditions and resubmit the listing. If the listing is reoffered, the process returns to operation 601. Otherwise, the process ends in operation 607. The listing may be stored in the history archives (data source 30A-30N) with all its data and the outcome of the listing.

In an exemplary embodiment, in addition to being able to Call the Deal during the active listing or shortly thereafter, the user may be able to Push the Deal. In an exemplary embodiment, while the listing is active, the user may modify the price of the available seats. The user may further Push the Deal by increasing the tipping point i.e., increase the overall rent amount that they wish to achieve.

Further, in an exemplary embodiment, the user may easily manage the leased space in the system. In an exemplary embodiment, the leased spaces may be managed directly in the same system. By way on an example, a user interface is provided which shows spaces that are in current leasing, spaces that are in active listing, spaces for which leasing time has expired (history) and spaces for which listings are in a process of being generated. In an exemplary embodiment, the user selects the currently leased spaces and may select a particular space within the list. For the selected space, each tenant may be shown with a number of sections, seats, and passes being leased. Further, for each space, contact information, lease term (move-in date and duration) may be provided. In addition, the monthly or weekly rent amount may further be provided and additionally, the active leases user interface may indicate whether each tenant has paid the current rent and when the next rent is due as well as ‘retry collection’, ‘cancel’, ‘extend’ or ‘change payment type’ payment functionalities via, in an exemplary embodiment, buttons that link these actions to the electronic payment solution.

In an exemplary embodiment, the user may be provided with an option to charge each of the tenants via PayPal or credit card on the rent due date or shortly thereafter. This is provided by way of an example and not by way of a limitation. Other electronic payment collection mechanisms are within the scope of exemplary embodiments. In addition, tenants whose lease expires within a preset predetermined period of time e.g., two weeks may be color coded in red. The user may decide to send a private listing offering a renewal of the lease to each tenant color coded in red or the private listing may be automatically set by the system once the lease is about to expire. Alternatively, a notification of a month-to-month extension (and subsequent cancellation procedures) may be sent to such tenant(s). Leases for a particular space that has just expired e.g., within a predetermined period of time such as 3 months, may be shown in grey. The user may include them in a private listing or the system may automatically provide the private listing for renewal for these expired spaces. In an exemplary embodiment, the user may collect the spaces for which the list has expired and any available passes and generate a new listing for public bidding.

In an exemplary embodiment, administrative functionality for the potential landlords is provided. The administrative functionality allows for automatically or manually collecting payments, managing active leases and passes, and generating new postings.

As explained above, in an exemplary embodiment, the user may change information for available seats on the fly while the listing is active e.g., the user may rearrange the seats differently, change sections, change passes, change prices (or they may be changed via automatically employed algorithm(s)), in real time for the available seats, change the tipping point. In an exemplary embodiment, other information in an active listing is not easily modifiable unless the listing is deactivated.

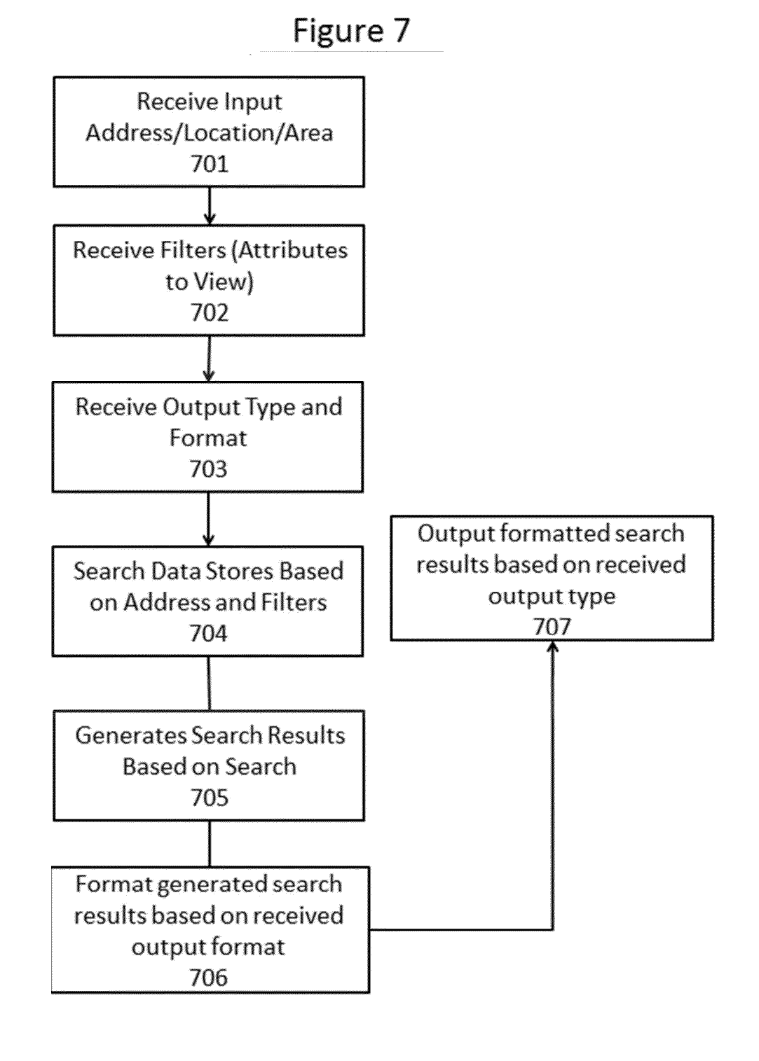

In an exemplary embodiment, a user (landlord and/or potential landlord) may obtain information about potential tenants in real time. For example, the user may analyze tenant data in the system by setting various filters, as described in greater detail with reference to FIG. 7. FIG. 7 is a flow chart illustrating a method of searching for potential tenants according to an exemplary embodiment.

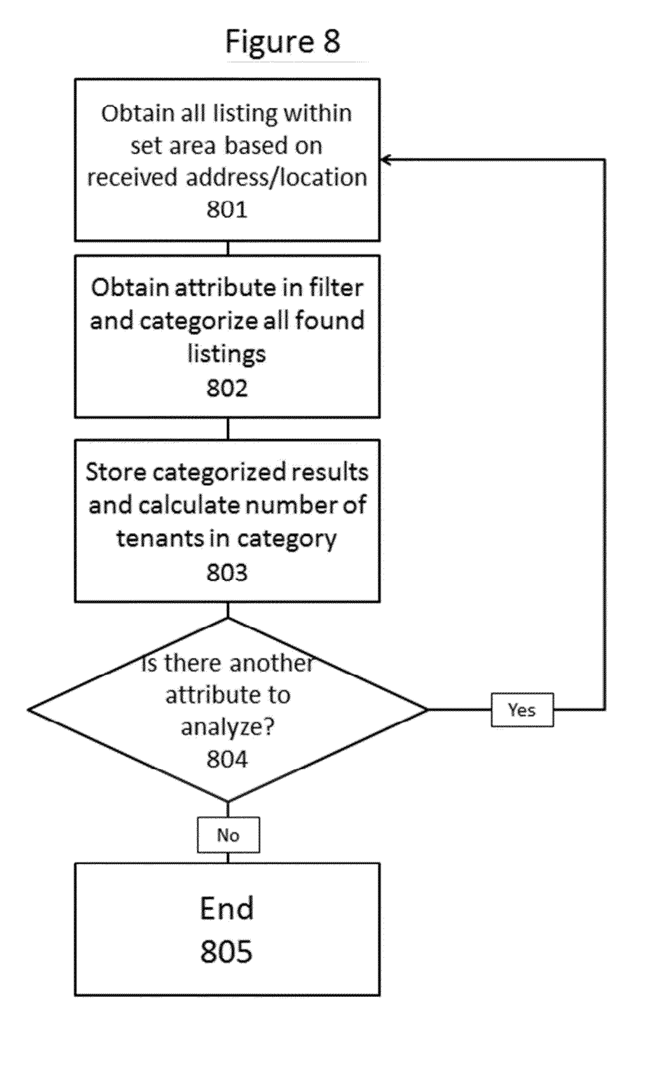

In an exemplary embodiment, the user inputs potential address or area location, which is received by the system in operation 701. Next, the user may set filters (attributes of interest). The set filters are received by the system in operation 702. For example, the user may wish to view all tenants that are bidding on spaces with a balcony versus spaces without a balcony, spaces in which the layout is office intensive versus spaces in which the layout is open. The user may further select output type and format, the system receives the set output type and format in operation 703. For example, the user may decide that data is to be directly output to the printer or stored in a memory (a local memory, a data store, and so on) or perhaps output on a screen, or any combination of the above. The user may further indicate whether the information is to be provided in a form of a graph, a chart, a heat map, interactive bar, or in a form of a list. Color coding, shape variations, and label variations may be used for improved presentation to the user. The system searches information in its database based on the received location information and filters in operation 704 and generates search results in operation 705 based on the information found in the search. In an exemplary embodiment, the system parses the data source based on the address information and filters, as detailed in FIG. 8.

FIG. 8 is a flow chart illustrating a method of searching for tenant preferences according to an exemplary embodiment. As shown in FIG. 8, in operation 801, the system parses listings stored in the data source based on the input address. In an exemplary embodiment, the user may simply draw a box around an area on a map or may select a particular address and a distance radius from the address e.g., input address of the USPTO and select 5 mile radius from the USPTO. In operation 802, the system obtains first attribute and categorizes all found listings into groups based on the attribute e.g., listings with outside space (check deck, roof top, balcony), listings without outside space (if not specified, the listing is considered as not having a balcony). Next, the categorized results are stored in a temporary memory such as cache, for example, in operation 803. Further, in operation 803, the system aggregates all tenants that have reserved seats, that have pending reservations, and/or that submitted a request for a reservation but have been rejected for the seats in each category. Next, the system checks if there is another attribute that needs to be examined. If another attribute is found in operation 804, the system returns to operation 802. If there are no more attributes, the process ends in operation 805.

Returning to FIG. 7, in operation 705, the search results are generated as noted above. The system may automatically combine various attributes and provide search results based on the combined attributes e.g., compare listings stored in category 1 for attribute A with listings stored in category 1 for attribute B, all listings that are present in both are to be displayed in blue on a graph, all listings that are present only in category 1 for attribute B and not A are to be displayed in red on the graph, all listings that are present only in category 1 for attribute A and not B are to be displayed in pink on the graph, all listings not present in category 1 of both attributes A and B are to be displayed as white on the graph. The user may flexibly set filters and combine parameters/attributes based on his or her unique needs.

In operation 706, the search results are formatted in the format set by the landlord and in operation 707, the search results are output in the selected output type.

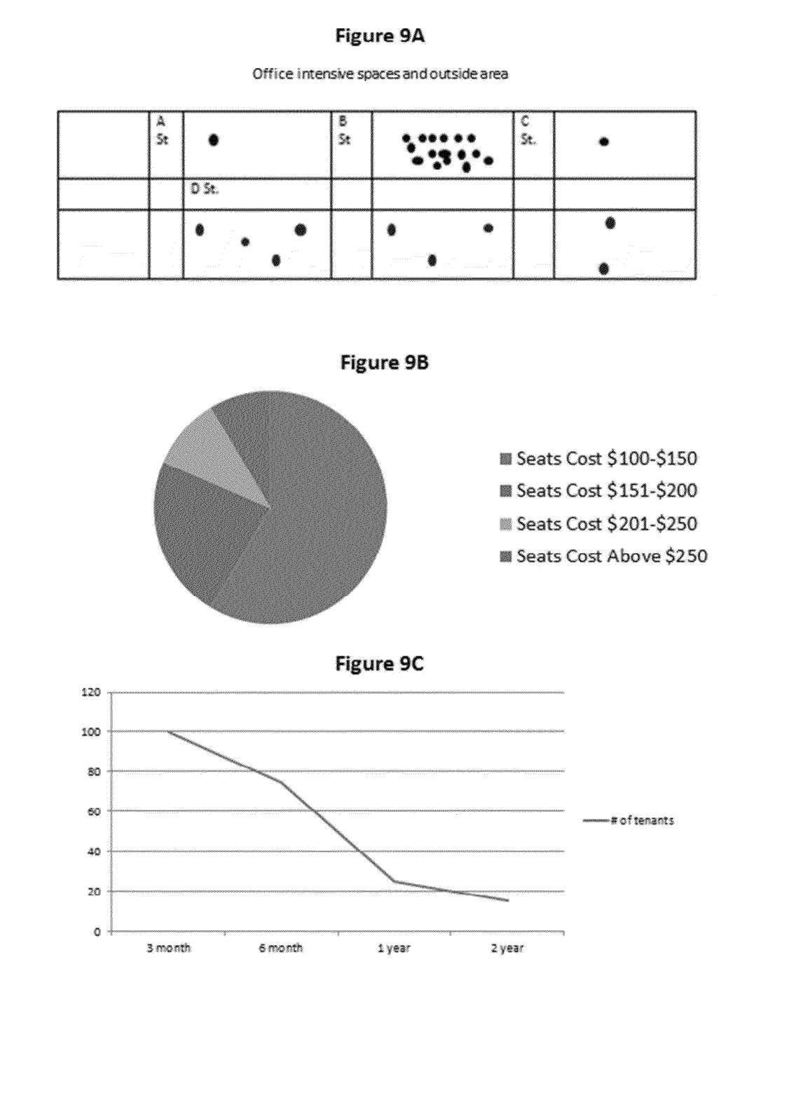

FIGS. 9A-9C are views illustrating displaying results of a tenant preference search according to various exemplary embodiments. For example, search results may be presented to the landlord in a form of a heat map, as shown in FIG. 9A. Specifically, in map 901, each tenant that meets the filter criteria set by the user is set as a point on the map, so the user can easily see the location desired by the tenants that meet the set criteria. For example, the user may have set filters to show all tenants that bid on office-intensive spaces with outside area. Of course, the heat map may also reflect space availability. In another exemplary embodiment, potential tenant profiles may be analyzed to determine desired factors by the tenants.

As described above, in an exemplary embodiment, analogous analysis of sections and/or passes may be performed.

In another exemplary embodiment, the search results may be displayed as a price range for a seat in a form of a chart, as shown in FIG. 9B. Of course, the user may further specify additional criteria to make the seats more equitable in considering the price. In yet another exemplary embodiment, the duration of lease as desired by the tenants may be provided in a form of a chart, as shown in FIG. 9C.

### Exemplary Tenant Component

A tenant component is configured to handle lease related actions taken by a tenant or potential tenant according to an exemplary embodiment. The tenant component is configured to handle user searches for a particular space, to handle user bidding for a particular space, to handle multiple bids, and manage user selected seats and/or sections and purchases related to leasing.

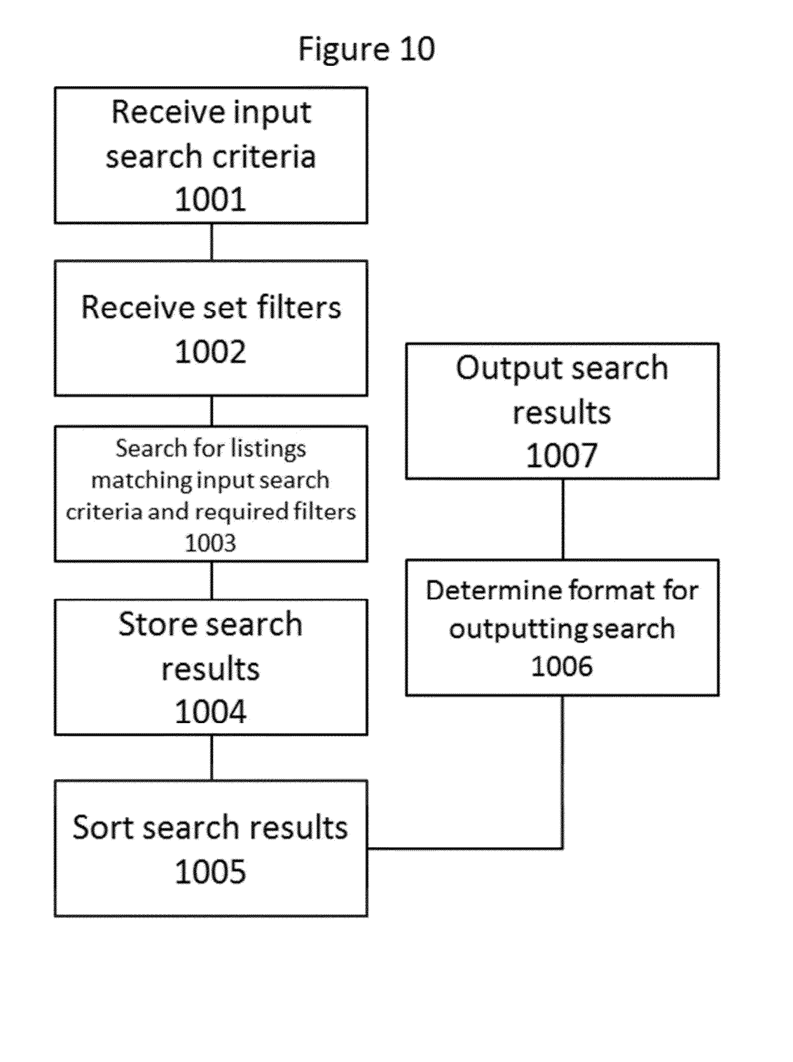

FIG. 10 is a flow chart illustrating a method of searching for a space according to an exemplary embodiment.

A user (a tenant or potential tenant) may search for a space by inputting an address or a location. The user may input a zip code, a name of the city, select an area on a map e.g. input address and radius, and so on. In operation 1001, the leasing system receives the input location. The user may further set filters such as price range per seat, number of seats needed, starting date and duration of time the space is needed for, equipment needed, and other options such as parking availability, outside area, and so on. Some attributes such as price and number of seats, for example, may be set as required and other attributes may be set as preferred. These filters may be set before the location is input, after the location is input or may be set together with the location. In an exemplary embodiment, the leasing system (the system) receives user set filters, in operation 1002. In operation 1003, the system accesses the data source and searches a pool of listings (a plurality of listings stored in the data source) based on the received location and the required filters. The listings matching the location and the filters may be retrieved from the data source and stored in a temporary memory such as cache in operation 1004. The system may then sort the search results based on the preferred attributes filters, in operation 1005. In an exemplary embodiment, the search results that most closely match all of the user input criteria and the set filters (including the preferred attributes) appear on top of the list. The system may then check the user profile to determine a preferred format for the search results, in operation 1006. For example, the user may specify that the search results are to be emailed, faxed, printed and/or displayed on a screen. The search results are to be provided in a form of a list, in a form of a table, and so on. The sorted search results are then formatted according to user preferred format and output to the user in operation 1007.

In an exemplary embodiment, the user may have the option of saving a search result. In an exemplary embodiment, the results of the search may yield a large number of listings e.g., over thirty. The user may review and select certain seats in a number of listings but may need to save the search to continue to review the search results at a later time. The user may select to save the search so as to access it at a later time.

In another exemplary embodiment, the user may specify criteria and based on the specified criteria, listings will be suggested. For example, the user may specify that there are ten employees that need ten seats and ten computers, at least one of which should be an office. Based on the specified criteria, the system may suggest available listings.

In another exemplary embodiment, a user may specify specific listings and/or users that such user wants to ‘follow’ (i.e., via a simple ‘follow’ button on the listing or user's profile), or otherwise receive regular updates on activity for. In such a manner, the users could more efficiently keep tabs on spaces and/or people in which or with whom they would like to collocate or otherwise transact leases in adjacent space with.

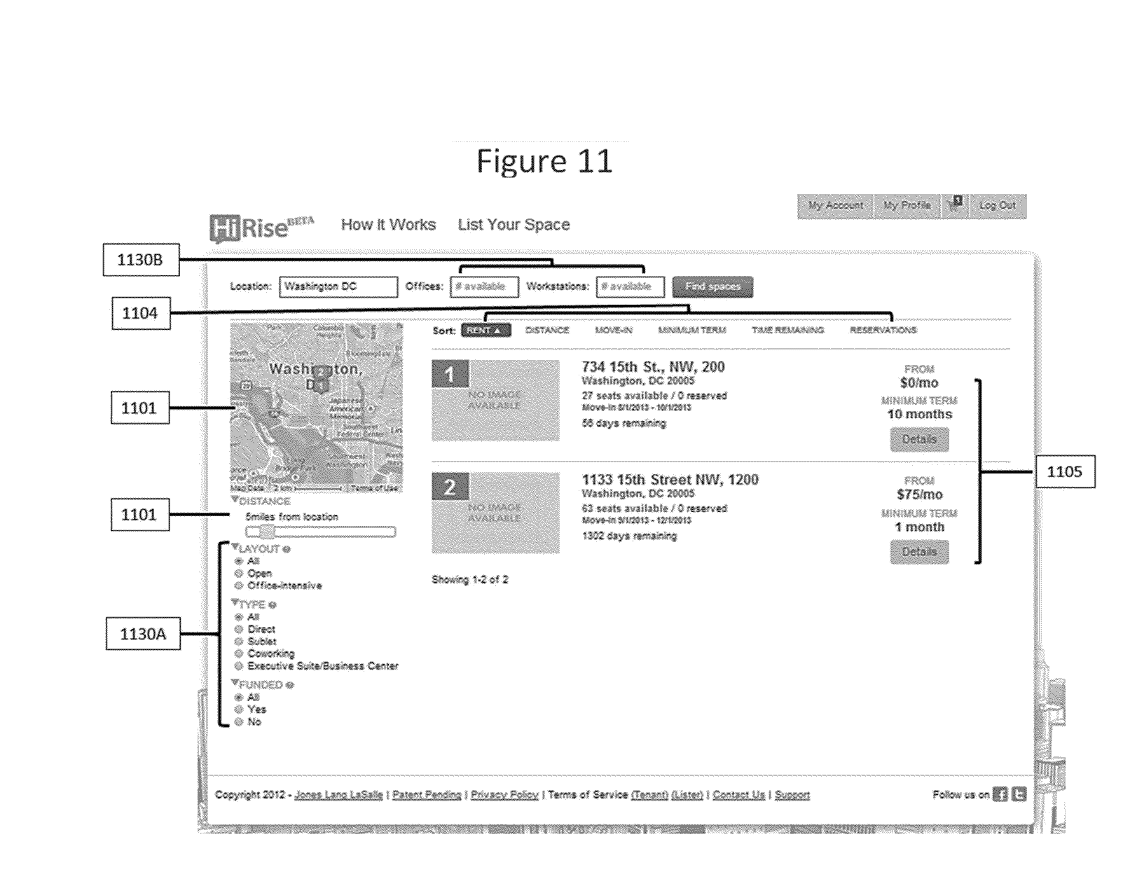

FIG. 11 is a view illustrating a user interface for searching for a space and providing results of a search according to an exemplary embodiment. As shown in FIG. 11, the user interface may include a map 1101 showing the location of interest. The user may further change the location by providing user input in a box 1102. The user may further set filters 1103a and 1103b such as layout desired, type of lease, and whether it is funded. That is, in an exemplary embodiment, the user may set the filter so as to view only spaces for which the tipping point has been reached or to view only spaces for which the tipping point has not yet been reached or to view all spaces. The user may further specify number of offices needed and number of workstations needed.

The user may further specify the sorting criteria 1104 e.g., set the preferred filters. For example, the user may set the sorting criteria such that the spaces for which the tipping point has been reached appear on top of the list. The user may wish to view the cheaper spaces on top of the list. The spaces may further be sorted based on a move in date, minimum term, time remaining for bidding, number of reservations, and so on. The results may be shown in a form of a list 1105. In another exemplary embodiment, the results may be provided in a form of a table and in various other known forms. Brief overview of each property may be included such as minimum amount of rent, minimum term, remaining time for the bidding, address, number of seats reserved and number of available seats, and a thumbnail image of the space.

In an exemplary embodiment, the user may further view currently leased spaces and also view private listings. In an exemplary embodiment, the user may view currently leased spaces so as to pay monthly rent or view the monthly rent that was automatically charged. The user may further view available amenities. For example, the newly available seats, sections, and passes for a particular space a portion of which the user is leasing may be provided in bold along with still available seats, sections, and/or passes. The bold would indicate that the seat/section/pass has been newly added, released, or modified since the user's past update.

In an exemplary embodiment, the user may further be provided with an update on tenants, new tenants may be shown in bold and existing tenant information may also be provided. The user may initiate a seat, section, and/or pass swap with one or more other tenants. The user may also view existing reservation, expiring leases, and so on and know who is sharing the space with the user. For example, the user may wish to swap seats to be closer to a new tenant who is a partner of the user. In an exemplary embodiment in addition to viewing seats/sections/passes for the space, tenants information may also be provided so the user can determine if space can be co-shared.

Moreover, in an exemplary embodiment, the user may further be provided with a private listing. The private listings are available to the selected individuals including the user. The private listing may be provided when a lease is about to expire or based on type of business, type of credit, recent searches, pass leasing history, and so on.

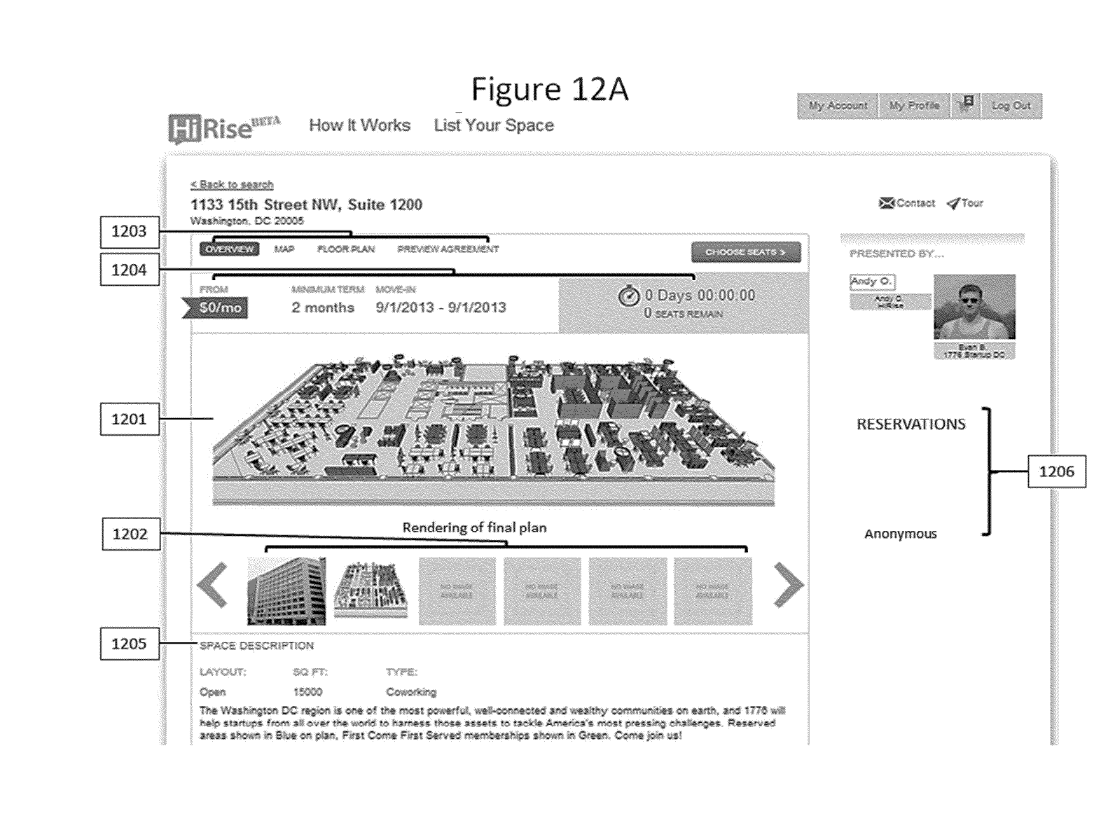

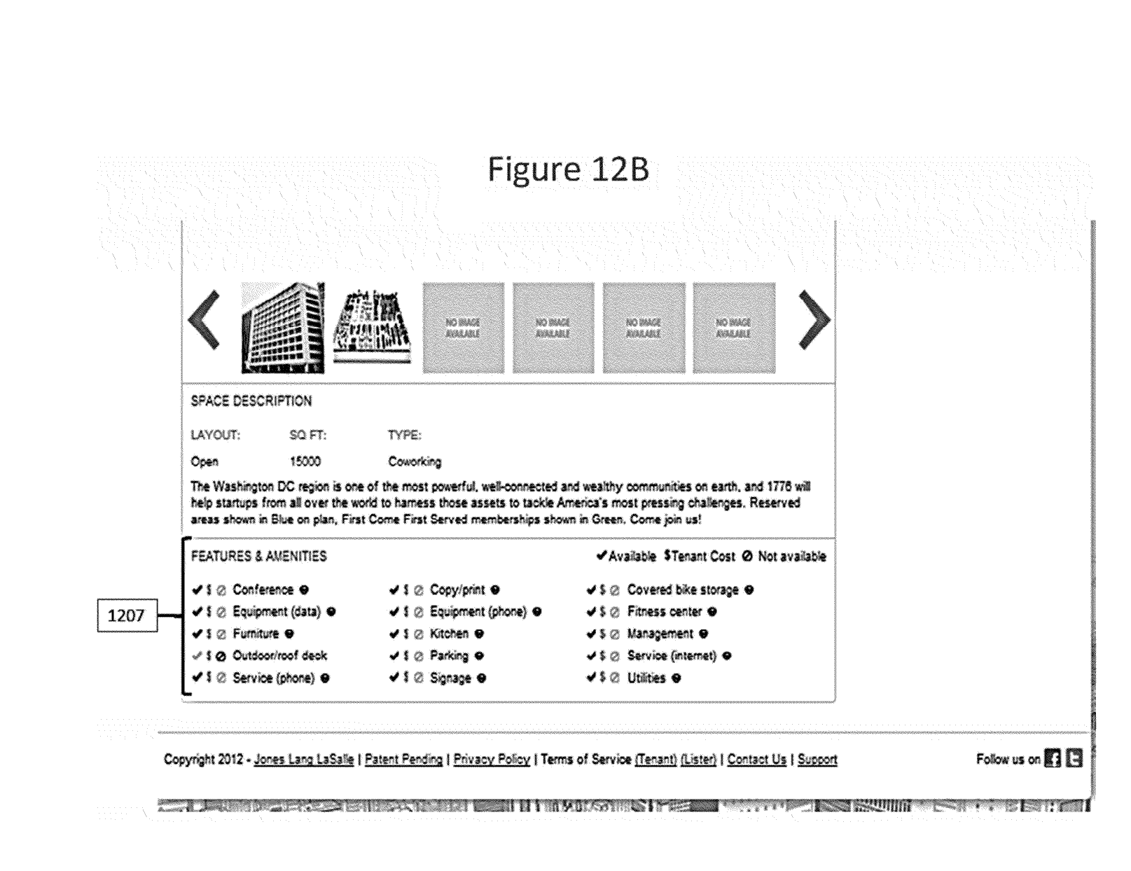

The user may further drill down, select a property of interest and view details of the property, as shown in FIGS. 12A and 12B.

FIGS. 12A and 12B are views illustrating a user interface for providing detailed information about a space according to an exemplary embodiment. As shown in FIG. 12A, when the user selects to view details of a particular listing, the user is provided with a main image of the space in an enlarged form 1201. The user is further provided with additional images 1202 that he or she may view in an enlarged form upon selection. The information about a list may be categorized 1203 and by selecting an appropriate option e.g., by selecting a corresponding link, the user may receive the information such as an overview description of the space, map of its location, a floor plan for the space with the seats and section (e.g., a seat map), an agreement for the lease that the user would need to sign to lease the space. Additional information 1204 such as a price of the cheapest seat, minimum term, move in range, number of available seats, price adjustments based on lease Term and/or quantity of seats and time remaining for the bidding may be provided. Detailed space description 1205 such as the square feet of an entire space, type of space, required deposit, and the layout may further be provided.

In addition, the user may view information on the tenants that have made reservations 1206. Since the space is potentially co-shared, the user may want to review the other tenants with which the space will be shared and their line of work. As shown in FIG. 12B, addition description 1206 of features and amenities may be provided and an indication whether the landlord included the respective feature, or whether the feature may be included for an additional cost, whether the respective feature is excluded, or whether the landlord did not provide any information with respect to the feature.

The prospect of tenants looking for workspace, and figuring out how to utilize and thereby pay for it ‘collaboratively’ (of course, within Landlord/Sublandlord defined parameters) and in a scalable way (what works for one or two entering a space could work for thousands who must fill up a very large vacant space) in an exemplary embodiment has opened up a revolutionary type of ‘search’ process for space that has not yet existed. The process and tools with which to organize how many occupants would pay for/fund, lease/take on liability for, insure and even utilize (down to the Passes controlling up to the minute utilization activities) packaged into the system allow for an experience where the users have the freedom to focus primarily, first and foremost, and quite simply, on who they want to work with.

In an exemplary embodiment, the integration of social networking on multiple networks that touch any potential tenant's social spheres—friends, business, ‘followers’, and the ability to tie in to the sharing abilities of these networks and thereby broadcast intentions outside of the system of who will be where, but also provides a large amount of data from which to offer suggestions, directly within the system, to those with similar profiles so they may find each other to share spaces under similar arrangements and circumstances. In an exemplary embodiment, tenants could be suggested based on the ones that follow or otherwise look at similar listings to other tenants in a certain industry. In yet another exemplary embodiment, tenants would be matched based on social sphere connectedness (i.e. 2 degrees of separation away and no more using social networks such as Facebook™ and LinkedIn™). In an exemplary embodiment, tenants with complementary skillets and profiles are matched up by the system, or they may self-match and form a cohort (of one or multiple companies) to simultaneously search for space and subsequently transact under. In another exemplary embodiment, tenants and Landlords/Sublandlords with complementary ‘profiles’ are matched to each other (potentially based on data on previous successful transactions and use cases).

In yet another exemplary embodiment, the tenant DATA becomes the marketplace, where Landlords/Sublandlords could be bidding their space directly to tenants (or groups of them) and ‘recruiting’. Not only does social matching provide more value to tenant users in the system to revolutionize the way that workspaces are searched for and subsequently transacted, but they could also quite possibly increase the chances of successful transactions in the system, provided the ‘right’ connections are made between any of the parties—tenant to tenant, tenant to Landlord/Sublandlord, or any combination. By focusing first on the driver for why they work together—who they will be with and who on any given day because they are ‘guaranteed’ to be there at most given times because they have a ‘reservation’—and the actual space and location of it second, the system may change the way real estate, and the process behind obtaining it is approached. In an exemplary embodiment, the focus may be on the people (tenants), then Place (space). In an exemplary embodiment, listings for pop-up workspaces where and when needed by the interactions that are to occur in them may be provided.

In an exemplary embodiment, not only is the space divided into seats and/or sections and/or passes. The leasing is based on a social network as opposed to attributes, location of the space first. That is, in an exemplary embodiment, potential tenant social information is shared and the user may search for spaces based on the social aspects. For example, the user may search for where the clients are and attempt to rent seats/sections/passes next to its client.

In yet another exemplary embodiment, social sites such as LinkedIn™ Facebook™, Classmates™, and so on may be used for searching available listings. The listings may then be provided based on closeness of the tenant or potential tenant to the user. Accordingly, in an exemplary embodiment, the user may view where friends, business contacts, and acquaintances are leasing space. In another exemplary embodiment, the listings may be provided based on where competitors are located or a filter may be set that would exclude displaying listings where potential competitors are tenants.

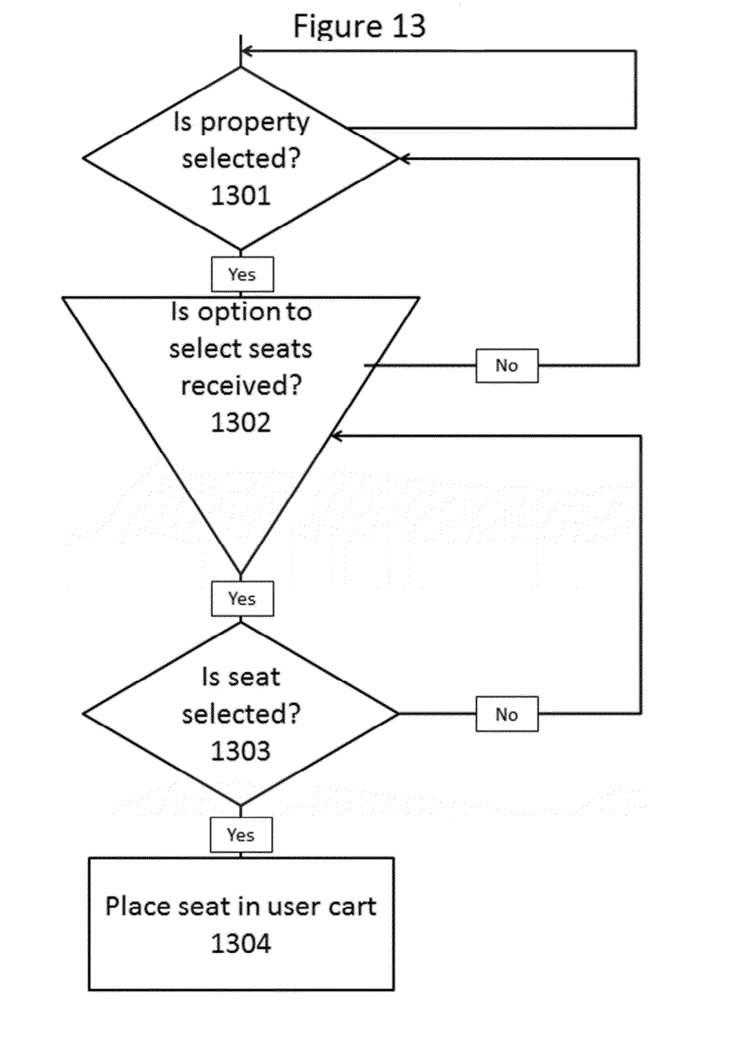

FIG. 13 is a flow chart illustrating a method of selecting seats in a space according to an exemplary embodiment.

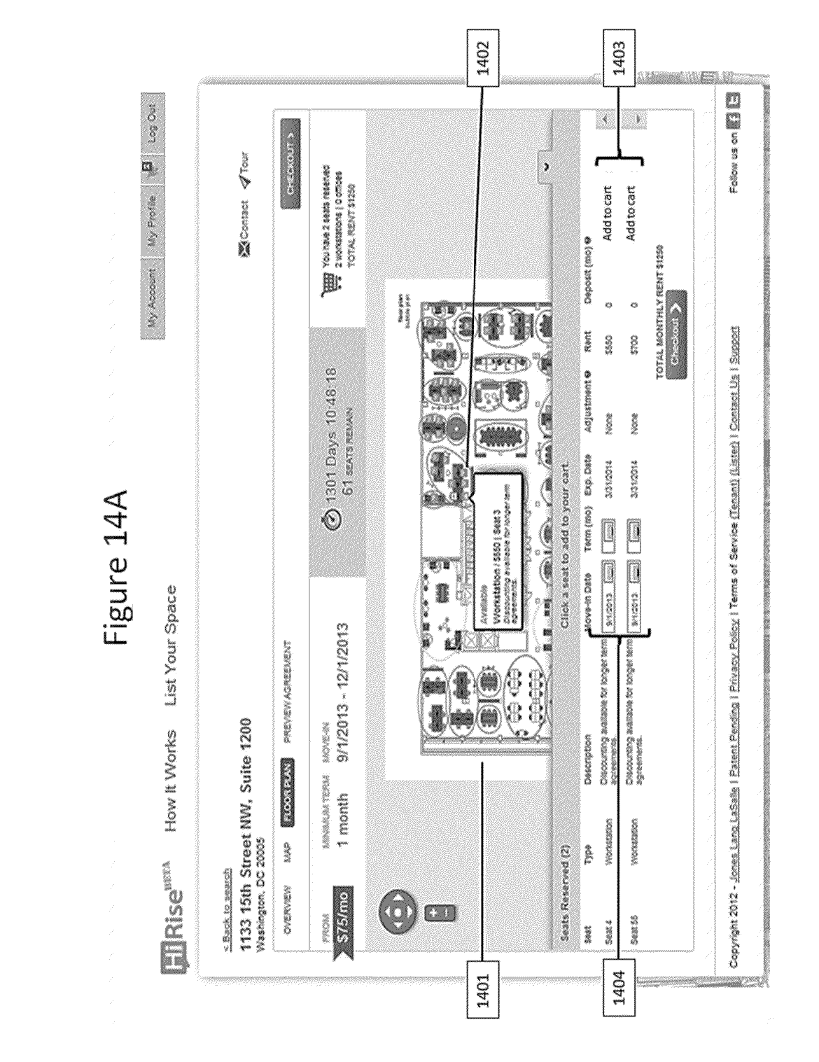

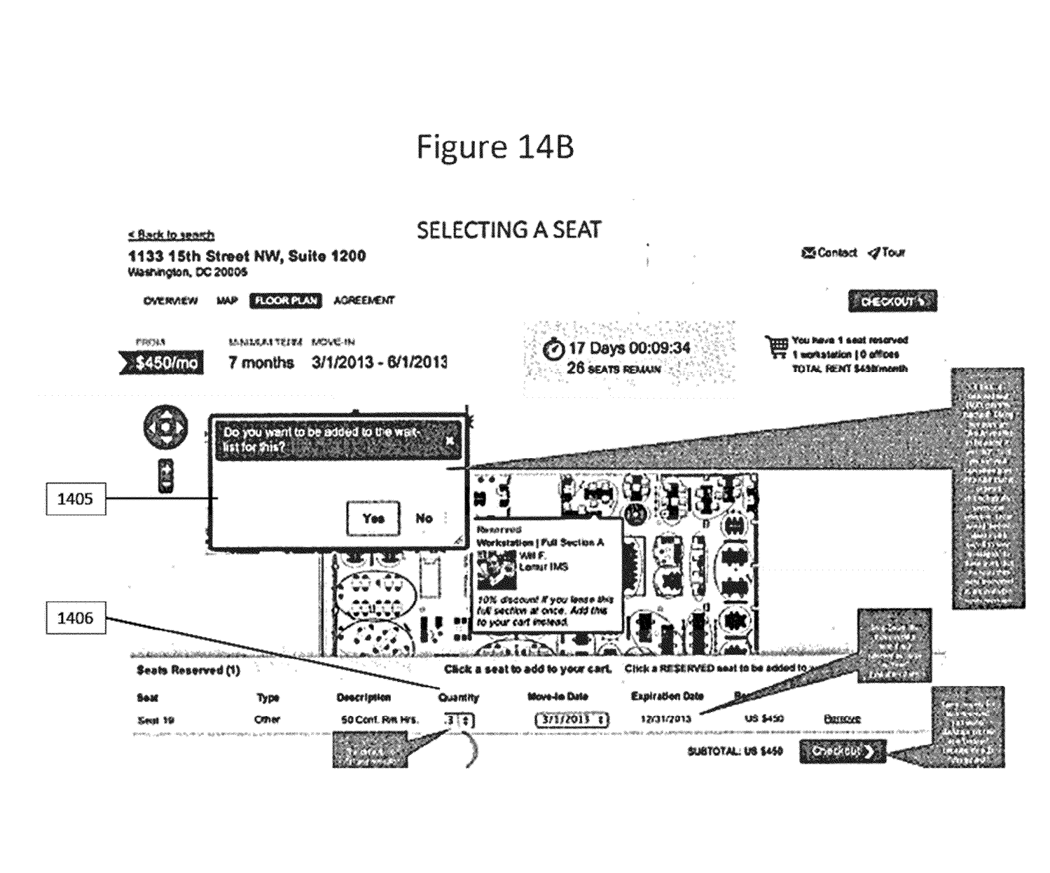

As shown in FIG. 13, the user may select a property and the system will receive a selection of a property in operation 1301. If the property is selected, the system then waits for the user to request a seat selection in operation 1302. If the user decides to select seats, the system receives the request for seat selection and provides a floor map 1401 for seat selection such as the ones shown in FIG. 14A. The user may select a seat or a section 1402 by simply clicking on a corresponding seat or a corresponding section shown on the map 1401. The user may be asked to confirm the selection and once confirmed, the seat or section may be added to the user's cart 1403. The user may be able to adjust the move in date and, where allowed, lease Term (and any subsequent volume or lease Term based adjustments/discounting would automatically apply) 1404. In addition, in an exemplary embodiment, the user may be able to select passes or to add amenities to the seat for an additional cost.

The landlord also has to approve the purchased seats. When the landlord approves the purchased seats, the reservation is confirmed. The confirmed seats reserved by the user may be shown in one color, the seats in the cart (unconfirmed reservations) may be shown in another color, and seats reserved by others (as well as meta-data about those individuals) may be shown in yet another color and appropriate labeling and tags.

As shown in FIG. 14B, the user may be able to adjust the quantity of the selected seats instead of clicking each seat individually. For example, the user may select a particular seat A and then indicate that five of these seats are needed. The system will then automatically find another four seats with the same characteristics as close as possible to the selected seat. If the remaining four seats are not together, the user will be notified. If four seats are not available, the user may be notified, as shown in FIG. 14B, 1405 and asked to be placed on a wait list.

The user selects a seat in operation 1303 and the seat is placed in the cart in operation 1304.

The user may view various properties and select various seats which are then added to the cart. When the user proceeds to checkout, the user requests a reservation of the selected seats present in the cart.

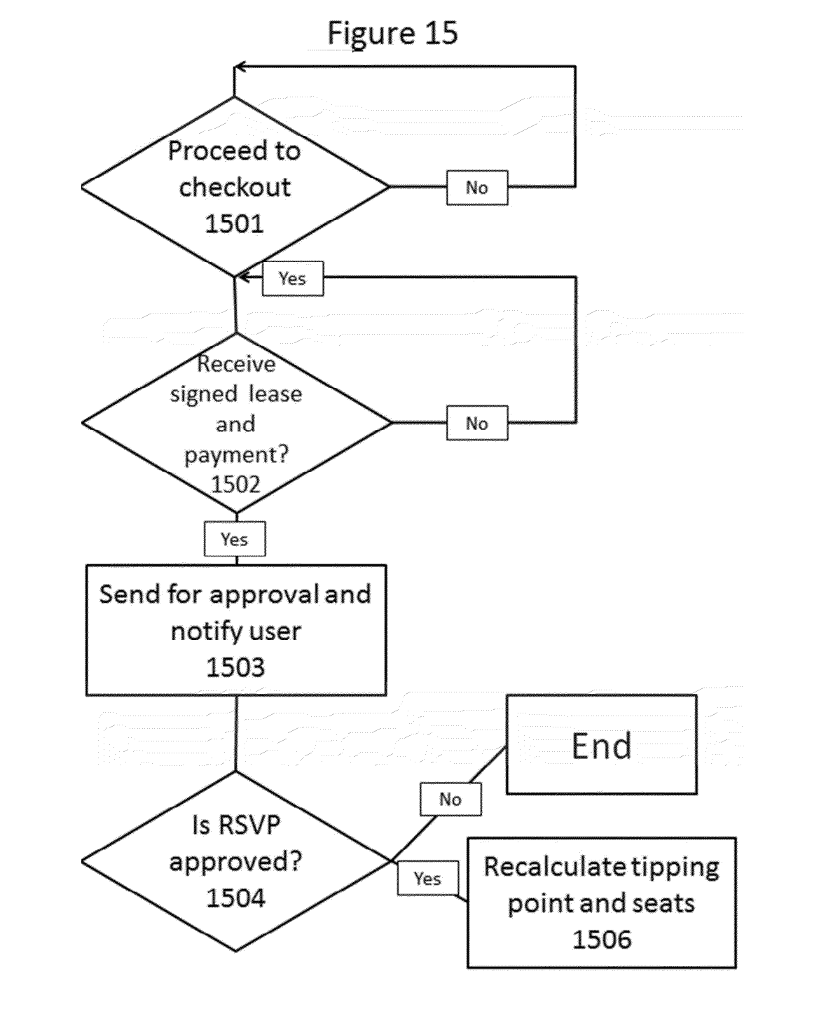

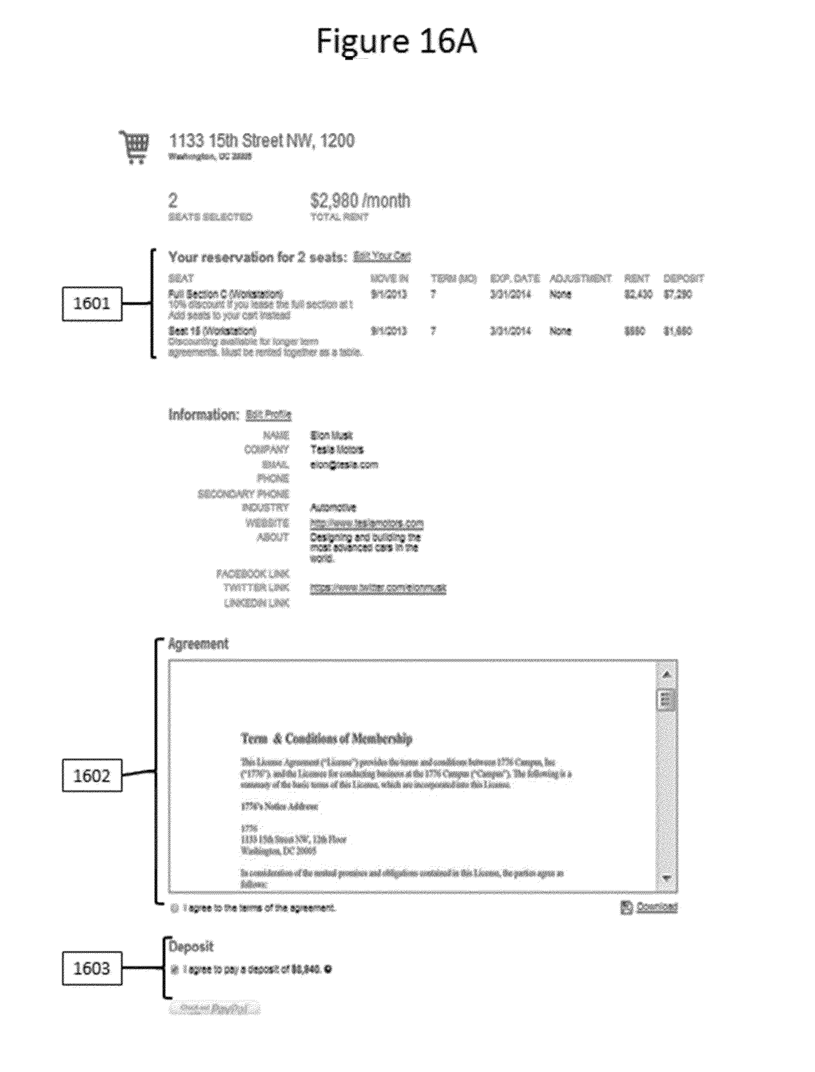

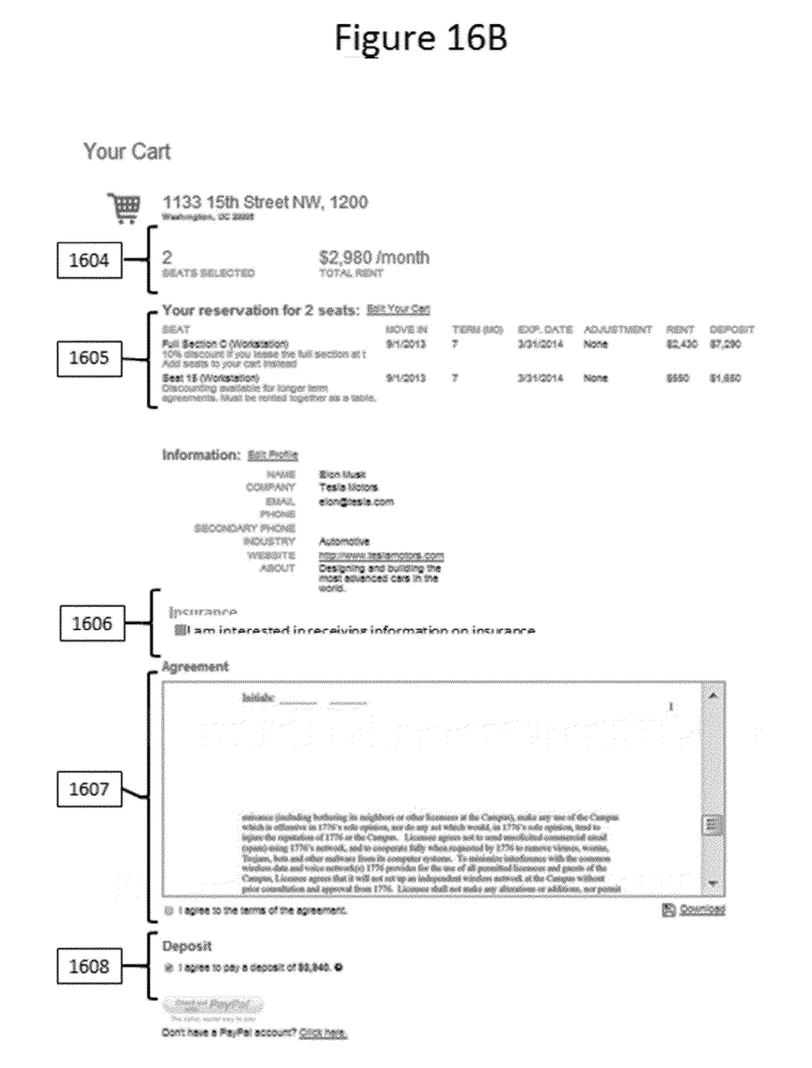

FIG. 15 is a flow chart illustrating a method of making a reservation of a selected seat or seats in a space or spaces according to an exemplary embodiment. In operation 1501, user request to proceed to checkout is received. The user is requested to review the cart 1601 shown in FIG. 16A, and to sign all corresponding lease agreement 1602, shown in FIG. 16A, and to pre-pay (or authorize or pre-pay the Deposit) for the seats 1603. In yet another exemplary embodiment shown in FIG. 16B, the cart includes number of seats being and total price per month 1604. The cart may further include a number of available seats, required deposit, move-in and move-out date that may be flexibly adjusted 1605. In addition, in an exemplary embodiment, insurance 1606 may be provided. The insurance may even be provided for passes such insurance is unavailable in the related art and is now provided only by way of aggregation.

In an exemplary embodiment, by aggregating leases, tenant insurance may be provided (as part of the transaction flow etc.). In an exemplary embodiment, the process is streamlined where the Landlords comply with lender and other stakeholder legal requirements regarding tenant insurance. In an exemplary embodiment, the entire transaction process from search, review, selection, insurance and proof of insurance and agreement execution is provided by the system online in one integrated application. By providing insurance by aggregating buyers, investment value for the landlord/investor is generated from the aggregated leases and/or a sub-landlords financial liability is mitigated/offset. These tenant leases mimic/mirror traditional lease transactions once complete thus are wholly accepted by the traditional real estate community and its stakeholders—lenders, investors, legal community and so on.

In an exemplary embodiment, custom lease agreement 1607 provided by the landlord is shown. Further, payment information 1608 is collected at the time of reservation. In an exemplary embodiment, the payment information 1608 may include the user (potential tenant) accepting to be charged a deposit amount (and/or subsequent rental payments), which would be listed. The payment may be collected via PayPal 1608. Further, the user may set up automatic monthly charge for the rent via PayPal. Ongoing rental payment could also be arranged outside of the system, and in person, mail, etc.

When all the necessary information is confirmed and input by the user, the system receives data in operation 1502. That is, in an exemplary embodiment, the system receives signed lease by potential tenant and payment or payment credentials i.e., if the tipping point has not yet been reached, the payment credentials are stored by the system. Accordingly, the system will charge the potential tenant once the tipping point is reached. In operation 1503, the system provides the pending reservation to the landlord for confirmation and notifies the user that a reservation has been made and is awaiting approval. When the landlord reviews the reservation, the landlord may deny the reservation, and the process ends in operation 1505. If the landlord approves the user in operation 1504, the system proceeds to recalculate available seats, reserved seats, tipping point for the listing in operation 1505.

In an exemplary embodiment, the system may further cancel other pending reservations for the user based on the first of such spaces to hit the Tipping Point. For example, the user may have bid on three different spaces as three possible alternatives. If his or her reservations are accepted and the space ‘tips’ in one of these three spaces, the pending reservations for the other spaces may automatically be canceled by the system. The system will know if these bids are part of the same ‘requirement’, thereby facilitating multiple bids for multiple requirements in, say, multiple locations.

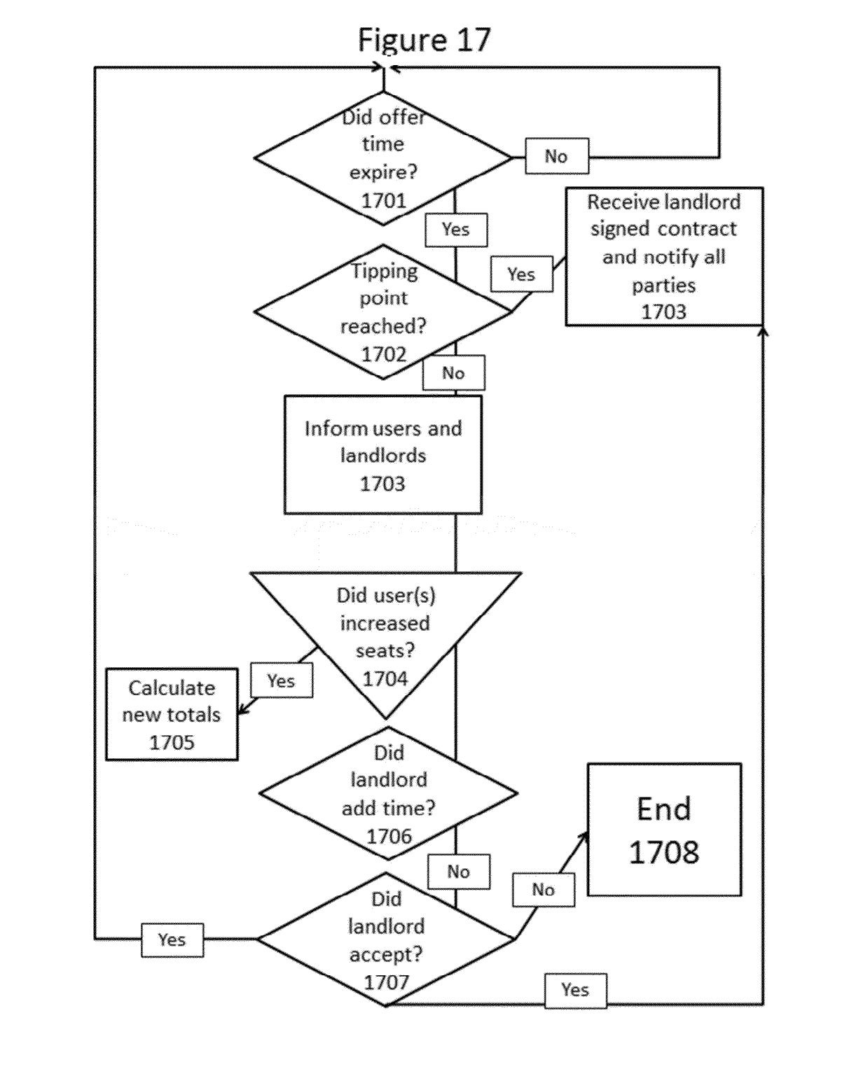

FIG. 17 is a flow chart illustrating a method of completing a lease related transaction according to an exemplary embodiment.

In operation 1701, the system checks if the bidding time set by the potential landlord has expired. If it has not yet expired, the posting remains active and the user may view and select seats e.g., as describe in an exemplary embodiment with reference to FIG. 16.

If the time has expired (Yes—in operation 1701), the system checks if the tipping point has been reached in operation 1702. If there are any outstanding pending reservations, the system may wait for the landlord to review additional pending reservations prior to checking the tipping point according to an exemplary embodiment. In another exemplary embodiment, pending reservations may be handled separately from existing reservations such that the landlord may accept the pending reservations within a predetermined time period after the offer has expired. The system may check if the tipping point has been reached after each of the pending reservations is accepted.

According to an exemplary embodiment, even if the tipping point is reached, the listing stays on a market as active unless removed by the landlord or its offer time expired. Once a reservation is accepted for a listing for which a tipping point has been reached, the user is charged for the deposit and/or first month rent. Further, the landlord may decide to close the deal at any time without taking any further action. In another exemplary embodiment, the landlord may call the deal without informing the users to add more seats to reach the tipping point and so on.

If the tipping point has or had previously been reached (Yes—in operation 1702), the initial and any subsequent agreements that were already signed by various users are deemed counter-signed by the Landlord, and all parties are notified that of the contractually binding leasing agreement in operation 1703. The potential tenants including the user are charged the pre-defined pre-paid items, or Deposits. In yet another exemplary embodiment, the landlord may be physically e-signing or thereby counter-signing the document. Accordingly, all parties are notified of a legally binding contact and all potential tenants are charged at this time. In yet another exemplary embodiment, the potential tenant may have been charged when the reservation was made with no documentation associated. As such, all parties are simply notified of a legally binding contract being created in the essence. Notifying the parties may include sending an email to the parties, automated call to the parties, and/or sending a message within the leasing system according to an exemplary embodiment.

If the tipping point has not been reached (No—in operation 1702) and all of the pending reservations have been reviewed and accepted by the landlord, all parties are notified in operation 1703. The user and/or other potential tenants may then be provided with an option to purchase more seats in operation 1704. If the user and/or other potential tenants purchase more seats (Yes—in operation 1704), new tipping point may be calculated in operation 1705 provided the landlord accepts their reservation requests. The tipping point is then again checked after each new reservation request is accepted in operation 1702.

If the user and other potential tenants did not increase the number of purchased seats (No—in operation 1704), the system checks if the landlord decided to add time to the listing in operation 1706. In an exemplary embodiment, the landlord may decide to post the listing for an additional predetermined period of time e.g., one day or two weeks. If the landlord adds time for the listing to remain active (Yes—in operation 1706), the system returns to operation 1701. On the other hand, if the landlord decides not to add time to the listing (No—in operation 1706), the system may then check whether the landlord accepted the transaction even though the tipping point has not been reached, in operation 1707. That is, the landlord may decide to accept existing reservation and perhaps, report the empty seats as a new listing.

If the landlord accepted the reservations even though the tipping point has not been reached (Yes—in operation 1707), the landlord may sign the lease agreements and all parties received a notification of the complete successful transaction. If the landlord decides to reject existing reservation because the tipping point has not been reached (No—in operation 1707), the system notifies all parties that the transaction was not successful and the listing is deactivated. The listing may be stored in an archive and the transaction ends.

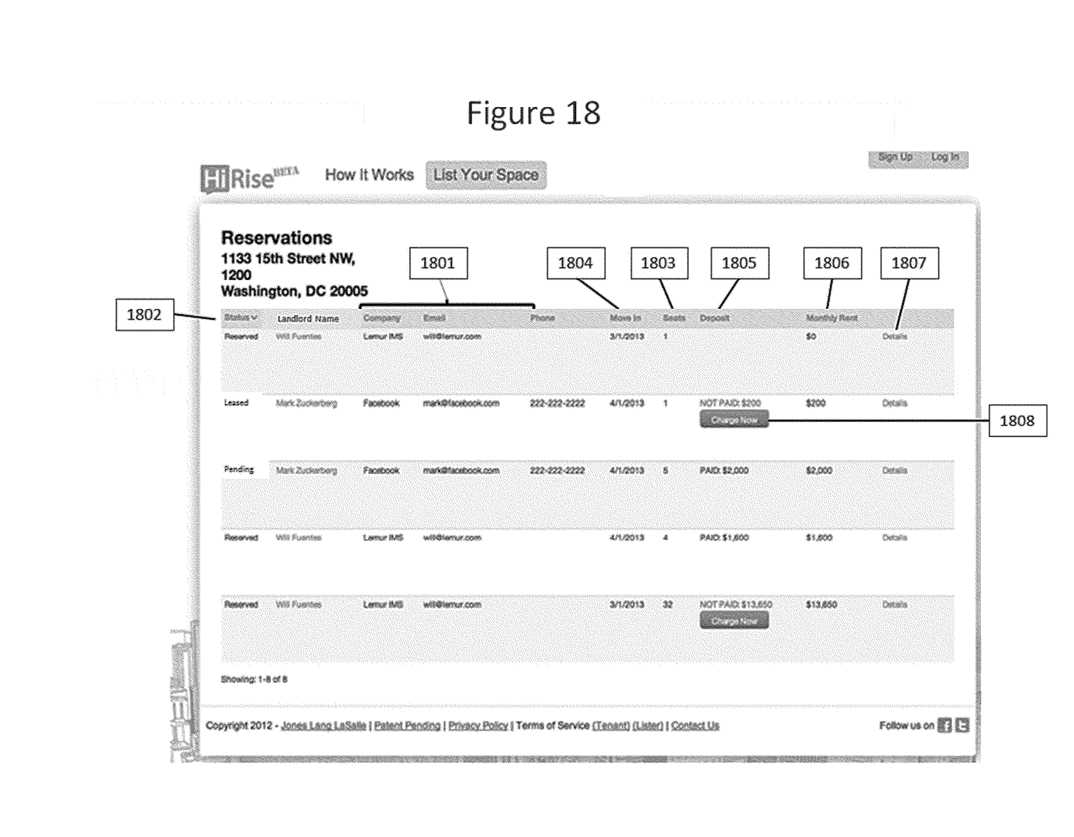

FIG. 18 is a view illustrating reserved space according to an exemplary embodiment. In view shown in FIG. 18, the tenant may view its list of reserved spaces. For each space, landlord name and contact information may be provided 1801. In addition, in FIG. 18, status 1802 of the space may also be provided. For example, the list of spaces may include a status of leased i.e., currently leased spaces, reserved i.e., accepted reservations that await expiration of the offer time and/or reaching the tipping point to consummate into a lease, pending reservation, for which a payment may have been made but the landlord has not yet approved the reservation. With each space, information about number of seats, sections, and passes may be provided in 1803. In an exemplary embodiment, if the user further selects seats or sections or passes, additional information regarding the item will be provided. For example, if the user selects seat 1803, a user interface which shows location of the seat on a floor map and its details, type and so on may be provided. Analogous user interface may be provided for the sections 1803. For the passes 1803, the user interface may include a table listing different types of passes and respective information for each in a form of a table. By further selecting passes, they may be viewed as an additional layer on a floor plan.

In addition, in an exemplary embodiment, move in date 1804 may be provided, which may be flexibly set by the tenant or may be indicated (at least a range) by the landlord. In addition, the lease expiration date may be displayed (not shown). The deposit collected 1805 and the month rent 1806 may be displayed. Additional details 1807 may also be provided. The user may pay the deposit 1808 and each monthly rent by using PayPal or other electronic payment mechanism. The user may set automatic monthly payments using the system. In FIG. 18, the view may be color-coded based on type of space (reserved, leased, pending reservation, or watching a listing—not yet bided on it). Further, display indicators may indicate leases about to expire, leases for which payment is due, overdue, and so on.

### Concluding Remarks and Additional Exemplary Features

Various exemplary embodiments for providing lease-related transactions have been described. In yet another exemplary embodiment, a tipping point may be an optional component and the lease-related transactions are provided in an auction type setting such that all the approved reservations are considered legally binding once the time expires.

According to yet another variation, the potential tenants may be able to offer ‘open’ bids on a seat such that a reservation with the highest bid (after the expiration of posting period for the listing) that is approved by the landlord wins the seat.

Another exemplary embodiment makes the lease term more modifiable such that the potential tenant may suggest a lease term when bidding on a seat. In this exemplary embodiment, the expiration time for the lease may be locked but the potential tenant may be allowed to specify his time for leasing within the allowed range. Different lease terms chosen may carry different terms as set by pre-determined rules by the Landlord/Sublandlord—for instance, the rent for a longer term would auto-populate with a discount, and, a larger deposit and/or pre-paid rental amount would auto-populate for such longer lease term.

Exemplary embodiments above describe a leasing of the space such as an office space. However, this is provided by way of an example and not by way of a limitation. Other exemplary embodiment may relate to a multi-family condominium. For example, families may bid for rooms in a vacation house or rent an apartment together. In an exemplary embodiment of a multi-family dwelling, each family will select rooms and amenities such as closets, bathrooms, the kitchen may be allocated to each family for a predetermined time and additional time may be purchased via passes. In an exemplary embodiment, other amenities such as the washer, dryer, television, telephone, computer, and so on may be shared via passes. Perhaps an entire floor in a new apartment building would be presented as sections representative of units, with special pricing for each unit garnered and offered to all tenants if/when the Tipping Point for a certain rent level for the floor is garnered.

Another exemplary embodiment may relate to data centers where a number of tenants lease servers/server racks. The traditional data center cycle is: developer builds data center specific building, then leases (or sells) to a ‘large’ data center operator or corporation who operates its own data centers or lease to multiple ‘smaller’ physical co-hosting operators or smaller corporations with own data center ops capabilities. In many ways this may mirror the office space cycle, where the landlord transacts with single or multiple users/tenants (tenant (demand) aggregation).

In an exemplary embodiment, during part 1 (physical asset) of the data center cycle, the system generates and focuses tenant demand resulting in aggregation of tenants or sole source (single tenant) transactions at any stage of the building life cycle—pre development, post-delivery, second generation (after initial tenants vacate) leasing (or sale). These tenants/users can find data center locations and consummate transactions in the same feature rich fashion as the above-described exemplary embodiments for office spaces. They (tenants/users) will cover the entire spectrum of end users—large corporations operating its own data center facilities, mid-size corporations with same intent but smaller physical requirement, to physical and virtual co-hosting operators. The system facilitates the aggregation of these users creating a larger demand profile—good for Landlords and developers.

During part 2, the system continues to aggregate demand for data centers. In part 2, the user/consumer demand for data center and cloud services are aggregated. In an exemplary embodiment, a unique demand driver is created by generating consumer level demand which in turn generates demand for more physical assets; completing the supply and demand loop by aggregating demand for both.

In part 2, according to an exemplary embodiment, the system for Data Centers will facilitate/generate the allocation and aggregation ‘tenant’/user demand of virtual hosting solutions. This market, in its infancy, is very challenging for consumer tenants/users to navigate as there is little to no standardization or transferable commonalities among providers. Data centers process/analyze user/tenant requirements, specific to the user based on user provided data, generating a user profile with data points or metrics that are used to source the appropriate solution (‘location’). This profile then is used to either sole source (tenant selected solution) or bid from a refined/filtered list of virtual hosting providers (listers). Once selection occurs, the balance of the transaction process is analogous to the one describe above according to an exemplary embodiment with respect to office space. That is, in an exemplary embodiment, the system includes listing time, bidding, agreements, payment methodology, access, all of which may be completed using the leasing system.

In an exemplary embodiment, the data center is capable of completing the entire business cycle for the data center industry. Not only delivering real estate solutions but generating and facilitating the consumer demand need by the tenants which in turn generates demand for more data center operator capacity which drives demand for real estate. The system delivers significant and unique industry changing solution.

Various exemplary components of the leasing system have been described above in various exemplary embodiments. The leasing system may be an integrated system or each component may be separately used with other system. In an exemplary embodiment, a particular component of the system may be embedded in another system. According to an exemplary embodiment, another system may be used to market the space and once the user decides to lease the space, the user is provided with the checkout component described above. Similarly, the space may be marketed using the above-described exemplary listings but once the user decides to lease the space, the user may be redirected to a different checkout component. In yet another exemplary embodiment, the user may generate the seating map using the leasing system described above but once the seating map is generated, the listing may be exported to a different system.

The flowchart and block diagrams in the Figures illustrate the architecture, functionality, and operation of possible implementations of systems, methods and computer program products according to various exemplary embodiments. In this regard, each block in the flowchart or block diagrams may represent a module, segment, or portion of code, which comprises one or more executable instructions for implementing the specified logical functions. It should also be noted that, in some alternative implementations, the functions noted in the block may occur out of the order noted in the figures. For example, two blocks shown in succession may, in fact, be executed substantially concurrently, or two blocks may sometimes be executed in the reverse order, depending upon the functionality involved. It will also be noted that each block of the block diagram and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or acts for performing the function in combination with other claimed elements as specifically claimed. The description of the exemplary embodiments has been presented for purposes of illustration and description, but is not intended to be exhaustive or limiting in the form disclosed. Many modifications and variations will be apparent to those of ordinary skill in the art without departing from the scope and spirit of the inventive concept. The exemplary embodiments were chosen and described in order to best explain the principles and the practical application, and to enable others of ordinary skill in the art to understand the inventive concept for various embodiments with various modifications as are suited to the particular use contemplated.

One exemplary embodiment resides in a computer system. Here, the term “computer system” is to be understood to include at least a memory and a processor. In general, the memory will store, at one time or another, at least portions of an executable program code, and the processor will execute one or more of the instructions included in that executable program code. It will be appreciated that the term “executable program code” and the term “software” mean substantially the same thing for the purposes of this description. It is not necessary to the practice one or more exemplary embodiments that the memory and the processor be physically located in the same place. That is to say, it is foreseen that the processor and the memory might be in different physical pieces of equipment or even in geographically distinct locations.

One exemplary embodiment also has a user interface invocable by an application program. A user interface may be understood to mean any hardware, software, or combination of hardware and software that allows a user to interact with a computer system. For the purposes of this discussion, a user interface will be understood to include one or more user interface objects. User interface objects may include display regions, user activatable regions, and the like. As is well understood, a display region is a region of a user interface which displays information to the user. A user activatable region is a region of a user interface, such as a button or a menu, which allows the user to take some action with respect to the user interface.

A user interface may be invoked by an application program. When an application program invokes a user interface, it is typically for the purpose of interacting with a user. It is not necessary, however, for the purposes of the inventive concept that an actual user ever interact with the user interface. It is also not necessary, for the purposes of the inventive concept, that the interaction with the user interface be performed by an actual user. That is to say, it is foreseen that the user interface may have interaction with another program, such as a program created using macro programming language statements that simulate the actions of a user with respect to the user interface.

Exemplary embodiments were chosen and described in order to explain operations and the practical application, and to enable others of ordinary skill in the art to understand various exemplary embodiments with various modifications as are suited to the particular use contemplated. That is, various modifications to these exemplary embodiments will be readily apparent to those skilled in the art, and the generic principles and specific examples defined herein may be applied to other embodiments without the use of inventive faculty. For example, some or all of the features of the different exemplary embodiments discussed above may be combined into a single embodiment. Conversely, some of the features of a single exemplary embodiment discussed above may be deleted from the embodiment. Therefore, the inventive concept is not intended to be limited to the exemplary embodiments described herein but is to be accorded the widest scope as defined by the limitations of the claims and equivalents thereof.

What is claimed is:

1. A method of leasing a space comprising:
receiving space location and space related information, which comprises information regarding at least one component within the space;
processing by a computer the at least one component based on a user request; and
outputting the result of said processing,
wherein the component comprises at least one of a seat, a section, and an amenity related to the space.

2. The method of claim 1, wherein the processing comprises generating a component map in which the at least one component is generated within the space based on the received space related information and wherein the space related information comprises at least one of a label, an identification of a type of the component, a size of the component, a price for the component, and whether the component is added to calculating a tipping point for leasing the space.

3. The method of claim 1, wherein the outputting comprises at least one of printing, storing, and displaying a newly generated seating map which is a floor plan for the space with the component being generated based on the received space related information.

4. The method of claim 1, wherein the processing comprises reserving the component based on the user request which comprises a user selection of the at least one component on the component map for the space and wherein the space related information is a search criteria input by a user comprising a necessary attributes for the at least one component and preferred attributes for the at least one component.

5. The method of claim 4, wherein the necessary attribute comprises at least one of a price, an identification of a type of seat, and a size of the seat and wherein the preferred attributes comprises at least one of additional amenities provided for the space as a whole or, in parts.

6. The method of claim 5, wherein the component type comprises, a workstation type of office space, an office type of office space and wherein the space is office space.

7. The method of claim 4, wherein the outputting comprises notifying a landlord of the space of a pending reservation, and further comprising: modifying the component map with the reservation based on input from the landlord,
wherein, if the landlord accepts the pending reservation, modifying the component map and a status of the at least one component to reserved,
wherein if the landlord denies the pending reservation, releasing the pending reservation and modifying the seating map and the status of the at least one component as available.

8. The method of claim 1, wherein the processing comprises posting the space as a listing for a predetermined period of time for bidding for components within the space.

9. The method of claim 8, further comprising receiving a tipping point specified by a landlord of the space, wherein the tipping point indicates at least one of minimum rent amount needed to be obtained from leasing components in the space to successfully complete a lease related transaction and minimum number of components in the space that need to be leased to successfully complete a lease related transaction.

10. The method of claim 1, wherein the processing comprises dividing the space into a plurality of components based on user input, and wherein each of the plurality of components shares is a type of workspace within a commercial space.

11. The method of claim 10, wherein the type of workspace is selected from among a group comprising of, for example an office environment, an open workstation, a cubicle, and an office.

12. The method of claim 1, wherein the processing comprises dividing the space into a plurality of components based on user input and aggregating at least two components into a section and providing additional attribute dedicated to the section based on additional user input.

13. The method of claim 1, wherein the processing comprises leasing the at least one component in the space based on user input and wherein the purchasing comprises electronically executing a leasing agreement by a purchaser and a seller and the purchaser paying for the at least one leased component.

14. The method of claim 1, wherein the space is an office or other commercial space and wherein the at least one component comprises an appropriate definable unit of such type of space, wherein the component comprises at least work seat within the commercial space.

15. The method of claim 14, wherein the component further comprises at least one pass for professional services, amenities, and equipment provided in the space.

16. The method of claim 1, wherein the space is a data center and wherein the at least one component comprises at least one data rack or a server.

17. The method of claim 1, wherein the space is a family dwelling and wherein the at least one component comprises at least one of a room or a bed in the family dwelling and wherein the at least one component further comprises additional services and equipment available in the dwelling.
